(19) United States
(12) Patent Application Publication
(10) Pub. No.: US 2023/0325064 A1
(43) Pub. Date: Oct. 12, 2023

(54) INTERACTIVE VISUALIZATION AND EXPLORATION OF MULTI-LAYER ALERTS FOR EFFECTIVE ANOMALY MANAGEMENT

(71) Applicant: AT&T Intellectual Property I, L.P., Atlanta, GA (US)

(72) Inventors: Gordon Woodhull, Beacon, NY (US); Yaron Kanza, Fair Lawn, NJ (US); Eleftherios Koutsofios, Berkeley Hts, NJ (US); Rajat Malik, Metuchen, NJ (US); Divesh Srivastava, Summit, NJ (US); Tamraparni Dasu, New Vernon, NJ (US)

(73) Assignee: AT&T Intellectual Property I, L.P., Atlanta, GA (US)

(21) Appl. No.: 17/717,494

(22) Filed: Apr. 11, 2022

(51) Int. Cl. G06F 3/04847; G06F 16/22; G06F 3/0482

(52) U.S. Cl. CPC G06F 3/04847; G06F 16/2246; G06F 16/2264; G06F 3/0482; G06F 2203/04806; G08B 5/22

(57) ABSTRACT

Aspects of the subject disclosure may include, for example, receiving, via an interactive user interface, user selections of a dataset and a first dimension of a plurality of dimensions in a hierarchical structure, wherein the dataset corresponds to a specific domain and comprises anomalies or alerts that are aggregated in certain dimensions, and wherein a lattice of aggregations of the anomalies or alerts is defined for the specific domain, causing the interactive user interface to present a time series chart and a heatmap, wherein the time series chart portrays alert density across dimensions below the first dimension, wherein the heatmap displays, according to a visual scheme, concentrations of the anomalies or alerts across at least a portion of the dimensions below the first dimension, and wherein user interaction with the time series chart and/or the heatmap facilitates navigation of subspaces of the lattice and exploration of the concentrations of the anomalies or alerts. Other embodiments are disclosed.

### FIELD OF THE DISCLOSURE

The subject disclosure relates to interactive visualization and exploration of multi-layer alerts for effective anomaly management.

### BACKGROUND

As the number (and variety) of complex systems deployed on the cloud continues to rise, the need for effective monitoring of these systems will only increase. For instance, it can be vital to monitor the flow of data streams between on-premises applications and the cloud, monitor content delivery networks, manage streaming data that feeds data lakes, and address or prevent anomalies in data streams that feed critical machine learning (ML) applications.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of an operational hierarchy for a cloud-based system that generates data streams, functioning within the communications network of FIG. 1 in accordance with various aspects described herein.

FIG. 2B depicts an illustrative embodiment of a method of generating smart alerts in accordance with various aspects described herein.

FIG. 2C depicts an illustrative embodiment of a method of generating baseline alerts in accordance with various aspects described herein.

FIG. 2D depicts an illustrative embodiment of a method of generating super alerts in accordance with various aspects described herein.

FIG. 2E depicts an illustrative embodiment of rolling up baseline alerts for generating super alerts in accordance with various aspects described herein.

FIG. 2F depicts an exemplary embodiment of using a dynamic quantile model to generate smart alerts in accordance with various aspects described herein.

FIG. 2G is a graph that depicts an illustrative embodiment of performance of a dynamic quantile model in accordance with various aspects described herein.

FIG. 2H is a diagram that illustrates an example of a smart alert and the individual lower-level alerts that contributed to the smart alert.

FIG. 2I is a block diagram illustrating an example, non-limiting embodiment of an interactive visualization and exploration system and an anomaly detection and alerting system, functioning within the communications network of FIG. 1 in accordance with various aspects described herein.

FIG. 2J shows example levels/sub-levels of one or more hierarchies in accordance with various aspects described herein.

FIG. 2K depicts an example time series chart in accordance with various aspects described herein.

FIG. 2L shows an example multi-dimensional heatmap of a user interface (or dashboard) provided by the interactive visualization and exploration system of FIG. 2I in accordance with various aspects described herein.

FIGS. 3A-3N show various views of an example user interface presented by the interactive visualization and exploration system of FIG. 2I, including a multi-dimensional heatmap and time series charts, in accordance with various aspects described herein.

FIG. 3O depicts an illustrative embodiment of a method in accordance with various aspects described herein.

FIG. 4 is a block diagram illustrating an example, non-limiting embodiment of a virtualized communications network in accordance with various aspects described herein.

FIG. 5 is a block diagram of an example, non-limiting embodiment of a computing environment in accordance with various aspects described herein.

FIG. 6 is a block diagram of an example, non-limiting embodiment of a mobile network platform in accordance with various aspects described herein.

FIG. 7 is a block diagram of an example, non-limiting embodiment of a communication device in accordance with various aspects described herein.

### DETAILED DESCRIPTION

Monitoring complex systems, such as data centers, data lakes, content delivery networks, and artificial intelligence (AI) applications, may involve the use of many sensors. Each of these sensors may produce a stream of data regarding a monitored component, and thus there can be numerous (e.g., thousands of) streams in a given system, and some streams may have varying associations or relations with other streams. In a case of monitoring a cluster of machines, there may be measurements per machine, such as measurements for memory usage, central processing unit (CPU) utilization, graphics processing unit (GPU) utilization, disk utilization, network load, CPU/GPU heat level, number of concurrent users, etc., and each measurement may refer to a particular entity/component, such as a physical machine, a virtual machine, or an application.

As described herein, various embodiments provide for complex multi-layer (or multi-level) aggregation of anomalies from different data streams, and corresponding generation of real-time (or near real-time) super alerts and smart alerts. Smart alerts, in particular, may distill thousands of anomalies into a manageable number of actionable alerts based on priority, persistence, pervasiveness, perseverance, and/or recency, and thus can prevent users (or system administrators) from being overwhelmed by the sheer number of detected anomalies. This reduces the load on human operators and prevents situations where users ignore or miss critical alerts simply because they cannot distinguish them from numerous non-critical ones.

While grouping anomalies in streams and generating super alerts and smart alerts (i.e., concentrations of super alerts), as described herein, reduces the quantity of alerts to a manageable number, each smart alert may nevertheless be a complex combination of anomalies, possibly detected from many different streams. Consider a hierarchy where there are applications running on virtual machines, where the virtual machines are deployed on physical machines or hypervisors, where the physical machines are located in data centers, and so forth. Events occurring in such a hierarchy can lead to multi-layered groups of anomalies. For example, a malfunction in a physical machine may affect virtual machines and applications running on the physical machine. In many monitoring systems, measured data may be aggregated in different dimensions, based on machine, time, type of measurement, and so on. In a case of anomalous heavy network traffic, there may be observable anomalies (or outliers) in the data streams of many machines at the time of an event, but the heavy network load might not affect certain measurements, such as those relating to memory utilization. Being able to identify the affected streams can help determine the underlying issue. In a different case, there might be several types of anomalies that are related to different measurements for a particular machine but that do not affect any measurements of other machines. Enabling a user to easily group anomalies and explore the various relationships between them (or between data streams from which the anomalies are detected) can help illuminate the event and, in some cases, facilitate root cause analysis to infer the cause of the event.

The subject disclosure describes, among other things, illustrative embodiments of an interactive visualization and exploration system that is capable of presenting complex, multi-layer (or multi-level) alerts (super alerts and/or smart alerts) in a concise and actionable manner. In exemplary embodiments, the interactive visualization and exploration system enables grouping of complex anomalies (detected in one or more data streams) and/or alerts and exploration thereof across various dimensions of a hierarchical structure, which facilitates identification of relationships or correlations between super alerts, smart alerts, attributes in data streams, and/or underlying events.

In exemplary embodiments, the interactive visualization and exploration system may (as described in more detail herein) present one or more time series charts that identify anomalies/alerts over time, and a multi-dimensional heatmap that represents concentration levels of anomalies/alerts according to a visual scheme (e.g., color coding by hue and/or intensity). The time series chart(s) and the heatmap may be spatially intuitive (e.g., representing information from left to right/top to bottom), and may facilitate navigation or traversal of a lattice of aggregations for a given domain that is associated with a hierarchy of dimensions, where alerts may be “rolled up” to specific dimensions in that hierarchy. For instance, in a domain where measurements are made for machine-related operations, and where the dimensions may include groups of machines, application type, measurement type, containers, hosts, time, and so on, the available levels of aggregations may correspond to these various dimensions. As described in more detail herein, the interactive visualization and exploration system may enable traversal of the lattice via “zoom in” and “zoom out” operations as well as via adjustments to ranges of the different dimensions that modify an explored subspace of the lattice.

Embodiments of the interactive visualization and exploration system, described herein, enable exploration of a complex event, the connection between anomalies (e.g., the lack of responsiveness of an application due to malfunction of an underlying physical machine), and correlations between events, which can assist with root cause analyses and ultimate identification and resolution of underlying issues. In situations where there is a large concentration of anomalies/alerts, attributes of the various data streams may indicate the root cause of a problem. For instance, a large concentration of anomalies/alerts being generated for thousands of data streams (or more) related to a small set of physical machines might suggest a problem with these particular machines, and the interactive visualization and exploration system facilitates drilling down into such concentrations of anomalies/alerts. Enabling alert exploration (in different perspectives and/or at different levels of aggregation or sorting), as described herein, also permits users functioning in different roles to focus in on measurements of interest—e.g., data scientists, operation engineers, operation managers, etc. may prefer different views of detected anomalies and/or may have other visualization or exploration needs.

While conventional visualization tools allow for analysis of time series and data streams, they generally lack capabilities for interactive exploration of multi-layered alerts over numerous data streams, and do not typically support aggregations of anomalies over these data streams across multiple dimensions. With the growing importance and prevalence of complex systems that need to be monitored, there is a greater need for an effective visualization and exploration system, such as that described herein.

One or more aspects of the subject disclosure include a device, comprising a processing system including a processor, and a memory that stores executable instructions that, when executed by the processing system, facilitate performance of operations. The operations can include receiving, via an interactive user interface, user selections of a dataset and a first dimension of a plurality of dimensions in a hierarchical structure associated with the dataset, wherein the dataset corresponds to a specific domain and comprises anomalies or alerts that are aggregated in certain dimensions of the plurality of dimensions, and wherein a lattice of aggregations of the anomalies or alerts is defined for the specific domain. Further, the operations can include, responsive to the receiving the user selections, causing the interactive user interface to present a time series chart and a heatmap, wherein the time series chart portrays alert density across dimensions of the plurality of dimensions that are below the first dimension, wherein the heatmap displays, according to a visual scheme, concentrations of the anomalies or alerts across at least a portion of the dimensions that are below the first dimension, and wherein user interaction with either or both of the time series chart and the heatmap facilitates navigation of subspaces of the lattice and exploration of the concentrations of the anomalies or alerts.

One or more aspects of the subject disclosure include a non-transitory machine-readable medium, comprising executable instructions that, when executed by a processing system including a processor, facilitate performance of operations. The operations can include obtaining a dataset from an anomaly detection and alerting system, wherein the dataset is associated with a plurality of dimensions in a hierarchical structure, wherein the dataset corresponds to a specific domain and comprises anomalies or alerts that are aggregated in certain dimensions of the plurality of dimensions, and wherein a lattice of aggregations of the anomalies or alerts is defined for the specific domain. Further, the operations can include presenting an interactive user interface that includes a time series chart and a heatmap, wherein the time series chart portrays alert density across various dimensions of the plurality of dimensions, wherein the heatmap displays concentrations of the anomalies or alerts across particular dimensions of the plurality of dimensions, and wherein user interaction with the time series chart or the heatmap facilitates navigation of subspaces of the lattice.

One or more aspects of the subject disclosure include a method. The method can comprise receiving, by a processing system including a processor, and from an interactive dashboard, a first user selection of a dataset and a second user selection of a first dimension of a plurality of dimensions in a hierarchical structure associated with the dataset, wherein the dataset corresponds to a specific domain and comprises anomalies or alerts that are aggregated in certain dimensions of the plurality of dimensions, and wherein a lattice of aggregations of the anomalies or alerts is defined for the specific domain. Further, the method can include, based on the receiving the first user selection and the second user selection, causing, by the processing system, the interactive dashboard to display a first time series chart and a heatmap, wherein the first time series chart portrays alert density across various dimensions of the plurality of dimensions, and wherein the heatmap presents, according to a visual scheme, concentrations of the anomalies or alerts across particular dimensions of the plurality of dimensions. Further, the method can include receiving, by the processing system, and from the interactive dashboard, a third user selection of a portion of the heatmap. Further, the method can include, based on the receiving the third user selection, causing, by the processing system, the interactive dashboard to display a second time series chart that portrays an individual metric without aggregation.

Other embodiments are described in the subject disclosure.

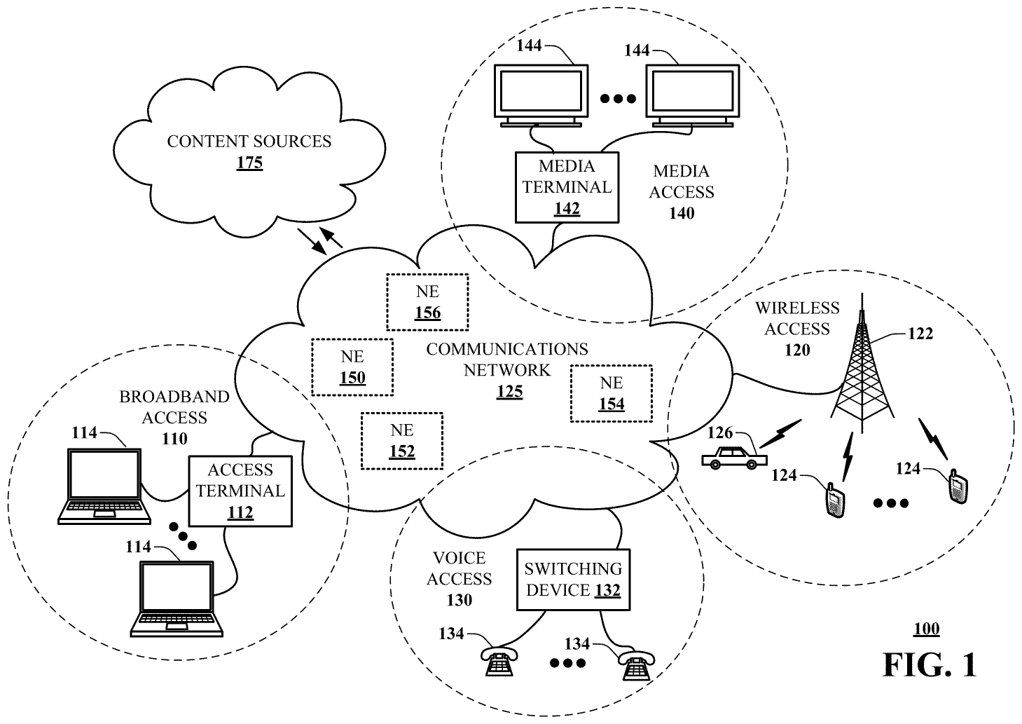

Referring now to FIG. 1, a block diagram is shown illustrating an example, non-limiting embodiment of a system 100 in accordance with various aspects described herein. For example, system 100 can facilitate, in whole or in part, interactive visualization and exploration of multi-layer alerts for effective anomaly management. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

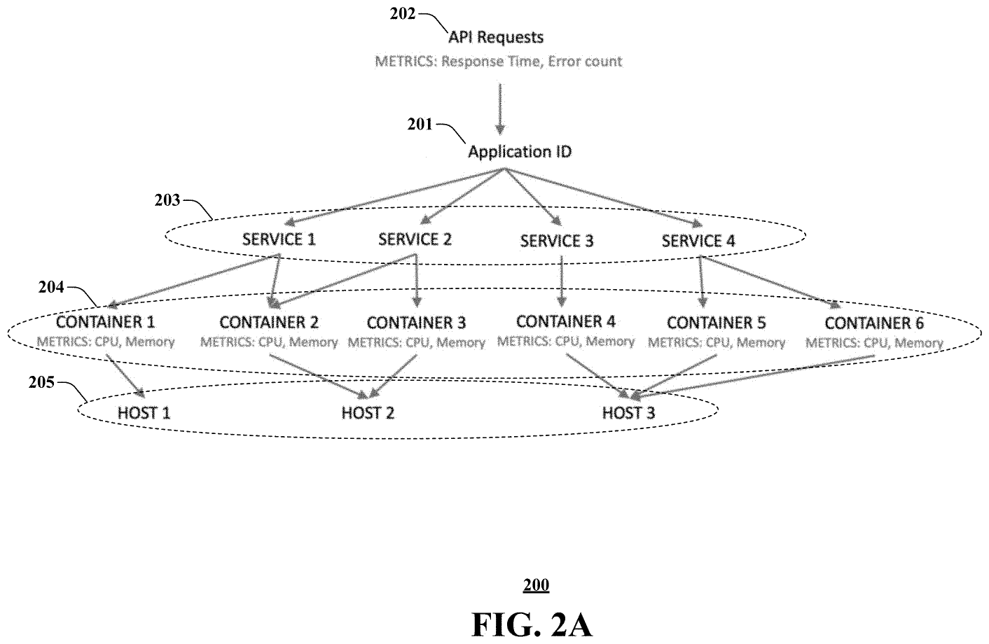

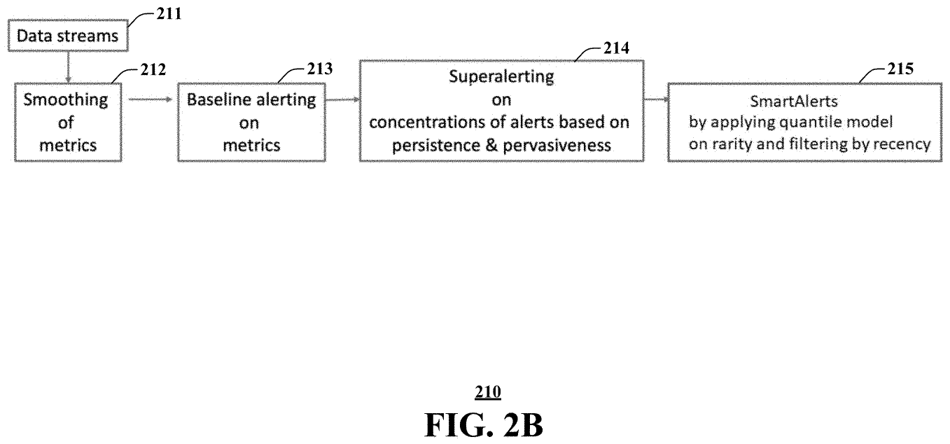

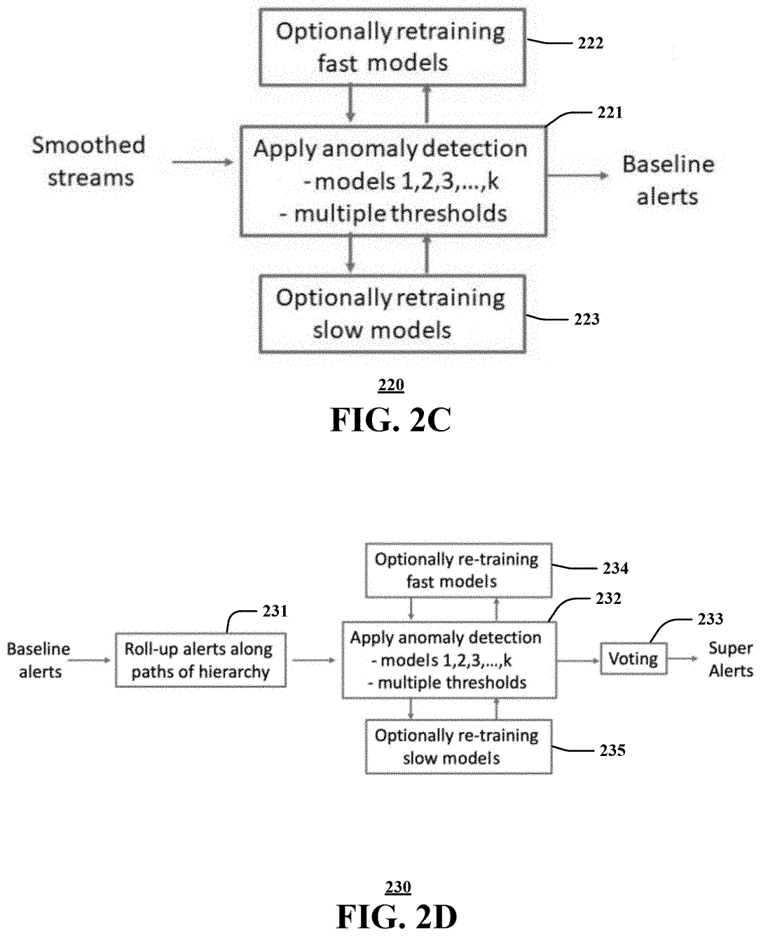

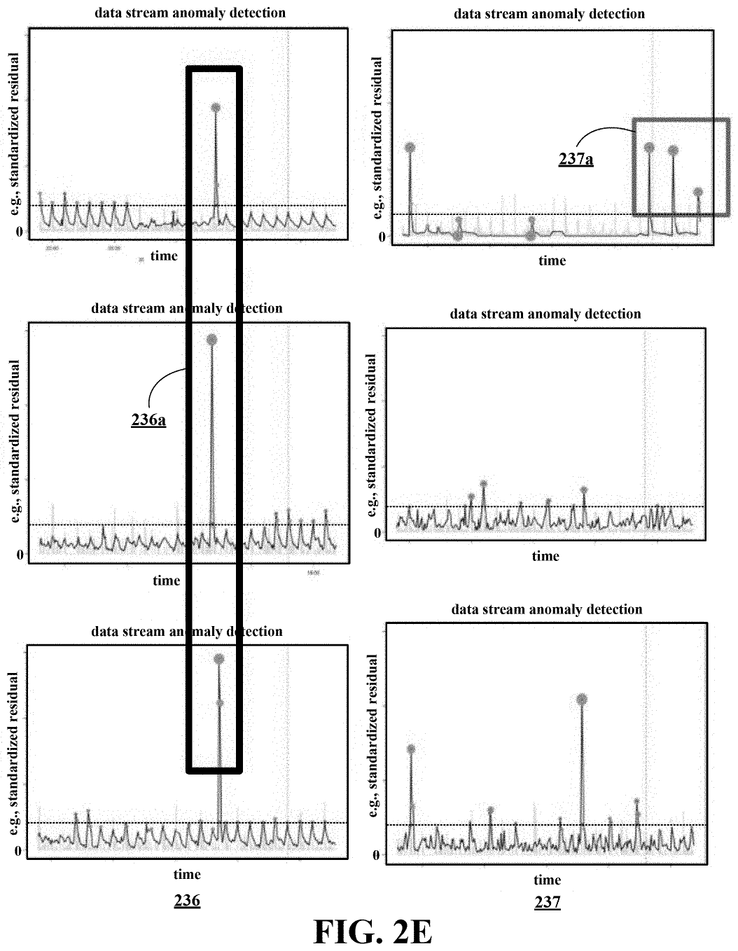

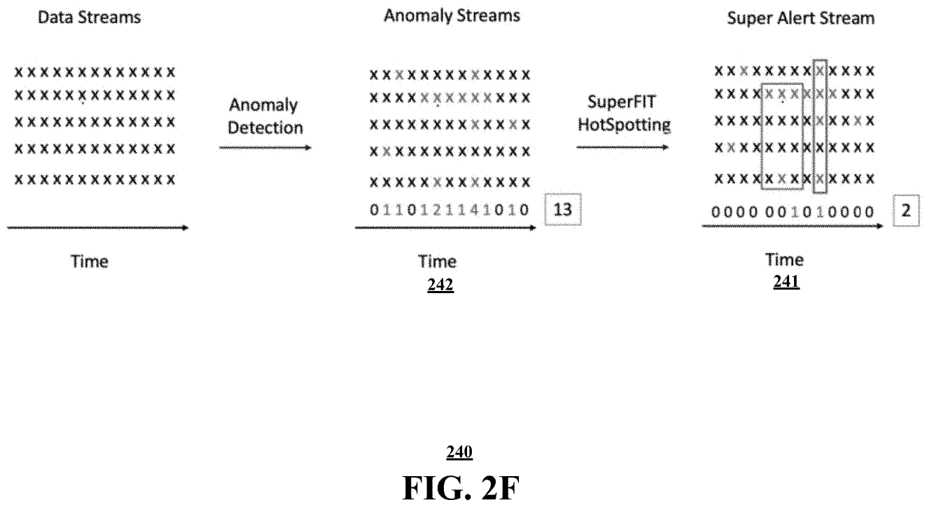

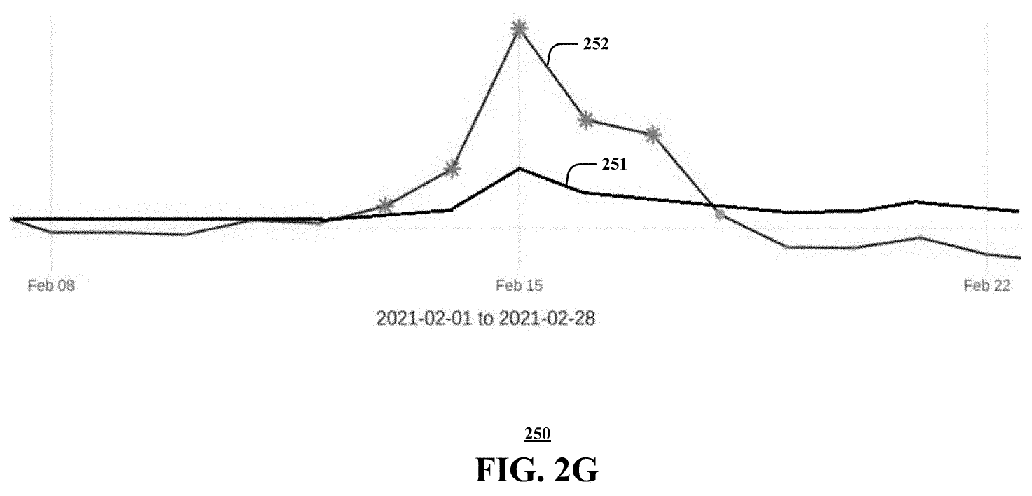

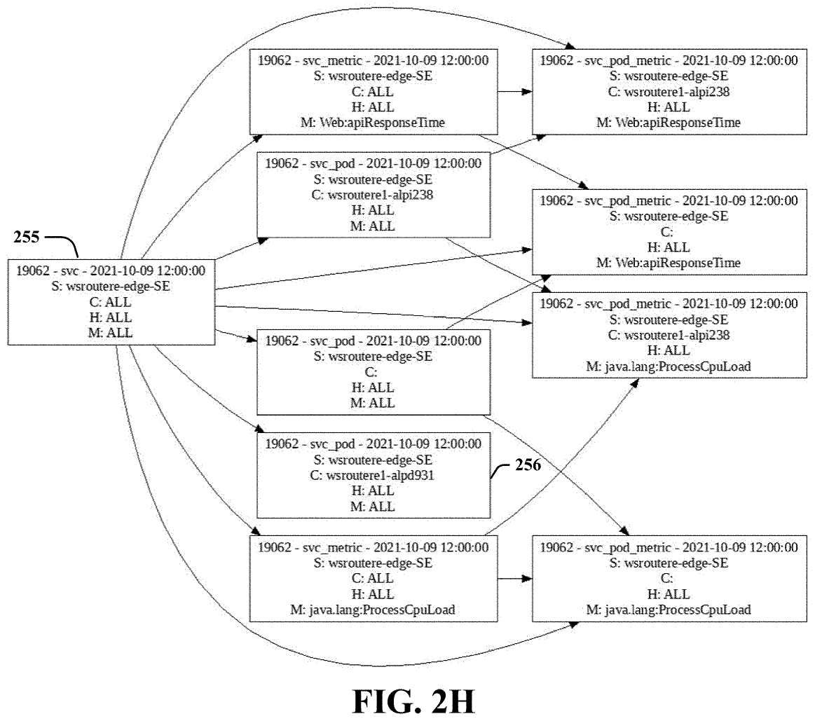

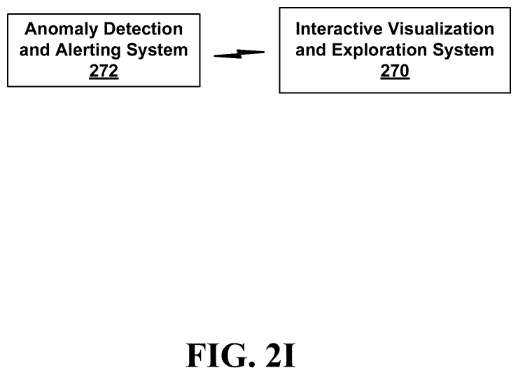

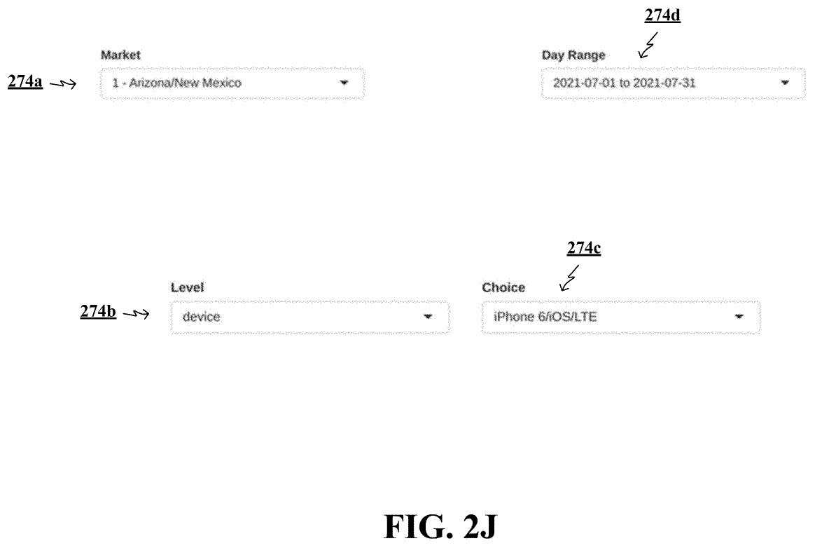

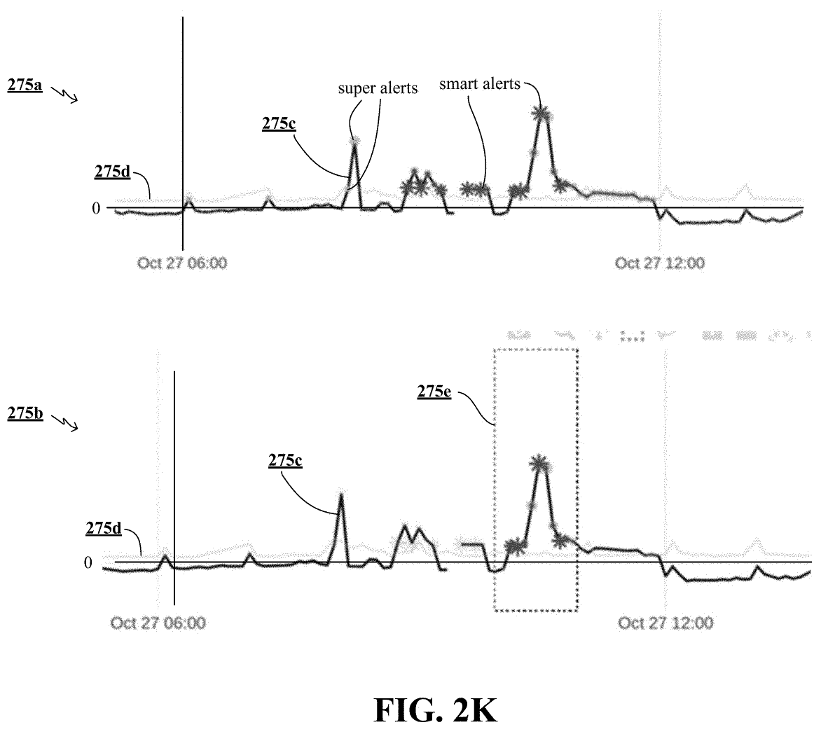

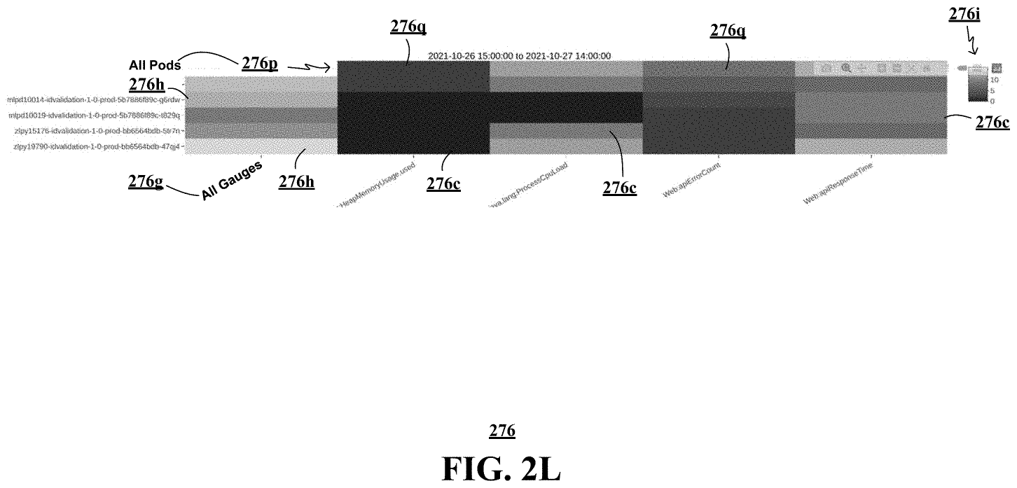

A data stream is a continuous set of temporal measurements associated with an entity described by a set of features. Modern anomaly detection scenarios have multiple streams, multiple objects, multiple components, and multiple metrics. Extant anomaly detection methods treat a single stream, single object, single component, and single metric, and issue too many alerts, even if just those occurring by statistical chance. Operations teams can be overwhelmed and ignore the alerts, missing critical events that could have catastrophic consequences. FIG. 2A is a block diagram illustrating an example, non-limiting embodiment of an operational hierarchy for a cloud-based system that generates data streams, functioning within the communications network 100 of FIG. 1 in accordance with various aspects described herein. The present technology can be applied to any hierarchical system that generates a plurality of data streams at one or more levels of the hierarchy. In the embodiment illustrated in FIG. 2A, the exemplary system comprises a cloud-based application 201 at the top of the hierarchy that is installed in the cloud and accessible via Internet API requests 202. In this exemplary embodiment, cloud-based application 201 is supported by one or more services 203. Services 203 provide features needed by cloud-based application 201. The performance of services is monitored via metrics, such as “process CPU usage,” “memory usage,” and “response time.”

In turn, each service 203 is supported by one or more containers 204. Containers 204 are software packages that contain everything needed to run software. Each container includes an executable program as well as system tools, libraries, and settings. By compiling all the components and keeping them in one place, containers 204 can transfer large packages of software with ease, ensuring that no key data is lost in the process. The software in containers 204 are executed on one or more hosts 205. Hosts 205 can be, for example, network elements 150, 152, 154, and/or 156, virtual machines, or physical servers (not illustrated).

A data stream is characterized by (1) dimensions that are descriptive features and typically categorical, and (2) a temporal measurement associated with each combination of the dimensions such that each combination of dimensions gives rise to a distinct stream of measurements. Data streams are always temporal, and data can arrive at any time, but typically, streams are aggregated to statistical signatures that align at desired frequencies, such as t1, t2, t3, which can be milliseconds, seconds, minutes, or any other time interval. For a given metric, there can be as many streams as there are combinations of dimensions. Each metric generates a data stream for any given path in the hierarchy in FIG. 2A. For example, there are three metric data streams associated with each combined key consisting of (application, service, container, host):
CPU(application, service, container, host)=cpu_t1, cpu_t2, cpu_t3, . . . .
Memory(application, service, container, host)=m_t1, m_t2, m_t3, . . . .
ResponseTime(application, service, container, host)=r_t1, r_t2, r_t3, . . . .

In a particular example, in the dimension hierarchy illustrated by the cloud-based application 201 shown in FIG. 2A, the dimensions are:
Application ID, e.g., 23901,
Names of the services they offer, e.g., “Loyalty Offers,”
ID of a container that supports the service, e.g., zlp11111-loyaltyoffers-1-4-bau-sldc-68598fc7f5-gd66q,
ID of a host that the container runs on, e.g., Host1, and
Name of the metric being measured, e.g., java.lang:HeapMemoryUsage.used.

Each combination of categorical features may have a stream of time-dependent measurements associated therewith. For example, consider that the specific combination of dimensions noted above generates a stream of (5-minute aggregate) measurements associated with it, e.g.:
2021-08-29 06:30:0011207.4
2021-08-29 06:35:0011234.2
2021-08-29 06:40:0011199.1
   where the average memory usage was 1207.4 units in the five-minute interval from 2021-08-29 06:30:00 to 2021-08-29 06:35:00, 1234.2 in the subsequent five-minute interval, etc. Other data streams may include temporal measurements on key performance indicators (KPIs) like Web:apiErrorCount, Web:apiResponseTime, java.lang:ProcessCpuLoad, and the like. Given thousands of applications in an enterprise with hundreds of services and dozens of containers for each service, each with tens of metric measurement data streams, any anomaly detection method, however accurate, will generate a multitude of alarms every hour, due to randomness of the metrics, resulting in a plethora of alerts that may not require any actions to correct.

FIG. 2B depicts an illustrative embodiment of a method of generating smart alerts in accordance with various aspects described herein. A system is designed to raise alerts around a set of alerts that occur more frequently than predicted by statistical chance, rather than upon the occurrence of single outliers. An architecture for such a system is set forth in more detail in co-pending U.S. patent application Ser. No. 17/699,969, entitled “ARCHITECTURE FOR SCALABLE SMART ALERTING ACROSS A MULTITUDE OF DATA STREAMS,” filed on Mar. 21, 2022, which is incorporated by reference herein in its entirety. Furthermore, in addition to syntactic constraints derived from statistical rules, alerts should be based on semantic considerations that help answer the question “what can be done to fix this problem,” thus making the alerts actionable. Semantic considerations consider the nature of the data streams (authentication application versus customer-care application), hierarchies and relationships between the streams, nature of the set of alerts (persistent in time, pervasive across multiple streams) to generate super alerts that could be sent to automated systems, and further identify an extremely small number of smart alerts based on recency, rarity and other semantic properties for potential human screening. Recency ensures that smart alerts are timely, and rarity, identified using the quantile model, ensures that the smart alerts are significant.

As shown in FIG. 2B, a method 210 begins with step 211, where a system collects a plurality of data streams. In step 212, the system smooths the input data streams. Such smoothing, for example, may consist of time weighted averaging over a period. Then in step 213, the system develops baseline alerts from the smoothed streams. A baseline alert is an alert generated for an individual data stream at the most granular time unit of measurement. Such baseline alerts can be binary (0,1), scores (e.g., p-values), or normalized deviations (2-σ). Baseline alerts are explained in more detail below in connection with FIG. 2C.

Next in step 214, the system discovers a concentration of alerts to generate super alerts based on persistence and pervasiveness of the baseline alerts, as explained in more detail below in connection with FIG. 2D. Finally in step 215, the system selects only significant super alerts based on priority, persistence of the anomalies, and pervasiveness over many streams or dimensions to generate smart alerts, as explained in more detail below in connection with FIG. 2E. The system also applies a quantile model of rarity and bases the selection by recency because recent events are more actionable than outdated events. This process is explained in more detail below in connection with FIG. 2F.

FIG. 2C depicts an illustrative embodiment of a method 220 of generating baseline alerts in accordance with various aspects described herein. As shown in FIG. 2C, in step 221, the system processes smoothed data streams by applying one or more anomaly detection models 1-k, consisting of multiple thresholds. The result is a stream of detected anomalies. In the process, new data are streamed through the baseline alerting module. The system can use that data for retraining the models. In step 222, the system retrains just the models of fast methods, i.e., those models that do not require much data to be trained. In step 223, the system retrains the models whose training is slow. Either step is optional, and the system may retrain all the models for creating baseline alerts.

FIG. 2D depicts an illustrative embodiment of a method 230 of generating super alerts in accordance with various aspects described herein. There are two stages to generating super alerts: (1) ingesting anomalies from individual streams and (2) finding important anomalies and hotspots of anomalies in time, and across multiple streams (different dimensions, combinations of different dimensions). As shown in FIG. 2D, in step 231, the system processes baseline alerts by “rolling up” along a path of the hierarchy, to discover significant groups of alerts. Such “rolling up” is illustrated in FIG. 2E below. Next in step 232, like in the method 220, different anomaly detection models are used having different thresholds. Then in step 233, voting is applied—a set of alerts is considered a super alert only if enough models agree that the set of alerts should be considered a super alert. In other words, only if the number of models that deem this set as a super alert exceeds a predefined threshold. As in the case of baseline alerts, retraining the models of the fast or slow methods is optional, at each of steps 234 and 235.

FIG. 2E depicts an illustrative embodiment of rolling up baseline alerts for generating super alerts in accordance with various aspects described herein. Super alerting runs anomaly detection on select aggregations, called rollups, which are either data-driven (“all containers that support a service”) or identified by additional topological information (“aggregated by containers that reside on nearest neighbors in a topological neighborhood of HOST1”). Super alerts represent anomalies that persist in time or affect multiple streams. Identifying a statistically significant concentration of anomalies, or hotspots, across multiple streams is the precursor to generating smart alerts that are multi-object, multi-component, multi-metric, i.e., affect many entities, and are potentially persistent. As shown in FIG. 2E, two examples of “rolling up” the hierarchy are illustrated.

In each of the graphs shown, the horizontal axis represents time, and the vertical axis represents an observed metric (e.g., in a standardized form). The horizontal dotted line (within each of the graphs) represents a threshold, which may be learned from historical data (e.g., self-learned by a corresponding anomaly detection/alerting model based on prior repeat alarms, user input, and/or the like). Values above the threshold may be considered dense or significant, and thus a concentration of “spiky” values over time or across different streams may be significant. In various embodiments, comparisons of the various graphs may provide insights on anomalies, as described herein.

In the first example, three graphs 236 depicted on the left side of FIG. 2E show baseline alerts that were detected at three distinct levels of the hierarchical structure generating data streams. Such pervasiveness meets the criteria for generating a super alert. For instance, each graph in 236 may correspond to a different data stream (e.g., provided by a respective sensor or application), where reference number 236a identifies anomalies across the different streams, which may be indicative of a multi-object event that is impacting a number of streams.

In the second example, three graphs 237 illustrated on the right side of FIG. 2E show three consecutive baseline alerts (237a) at a particular level of the hierarchy. Such temporal persistence of baseline alerts meets the criteria for generating a super alert. However, super alerts are insufficient for filtering enough alerts to a manageable level, so further correlations are needed.

FIG. 2F depicts an exemplary embodiment of using a dynamic quantile model to generate smart alerts in accordance with various aspects described herein. As mentioned above, super alerting runs anomaly detection on select aggregations, called rollups, that are either data-driven (“all containers that support a service”) or identified by additional topological information (“aggregated by containers that reside on nearest neighbors in a topological neighborhood of HOST1”). The system ranks super alerts based on their persistence, pervasiveness, priority, and recency. The super alerts and their deviation of density from the expected super model are put through a dynamic quantile model based on historical data and are further filtered based on recency to generate smart alerts. In an example 240 shown in FIG. 2F, anomaly detection on such aggregations expects a certain level of noise (anomalies due to pure chance) and identifies only concentrations that are over and above the normal level of noise. A roll-up shown in chart 242 illustrates that 0, 1 anomalies are acceptable since they happen quite often. But as chart 241 illustrates, three super alerts in a row on the same stream and anomalies on at least two streams leads to the generation of smart alert #1. Similarly, four simultaneous anomalies across multiple super alert streams are uncommon, which leads to the generation of smart alert #2. Smart alerting finds such regions of high density of anomalies in a continuous data-driven manner. Note that each smart alert encapsulates many connected anomalies, but results in a single actionable notification. As shown in chart 242, any standard anomaly detection method on individual streams would have resulted in 13 anomalies in 9 out of the 13-time instances, whereas smart alerting generates only two alerts, as shown by the rectangles in chart 241.

Thus, a smart alert may be a subset of super alerts. Where a super alert may be determined algorithmically, filtering may be applied—e.g., based on recency criteria, concentration criteria, and so on—to focus in on events of interest. Filtering may be user-defined and/or self-learned by the system (using one or more ML models). In various embodiments, only groups of anomalies that are dense and significant (e.g., based on priority, recency, pervasiveness, etc.) may yield a super alert, and only a dense group of super alerts in a brief period (e.g., within a threshold period of time) may trigger a smart alert. In certain embodiments, application type may also be user-defined for anomaly detection—e.g., where anomalies associated with a particular application are to be alerted to the user. In any case, filtering or alert concentration provided by the smart alerting algorithm may help determine whether issues are occurring on the same virtual machine, on different virtual machines running on the same physical machine, or across different virtual machines running on different physical machines.

FIG. 2G is a graph 250 that depicts an illustrative embodiment of performance of a dynamic quantile model in accordance with various aspects described herein. A dynamic quantile model entails computing quantiles in a continuously evolving manner based on a sliding window of historical data, e.g., the data from the most recent 24 hours. Quantiles divide the sorted data into equal parts. For example, percentiles are specific instances of quantiles that divide the sorted data into 100ths, where any given percentile, e.g., 84th percentile, would be the value that is greater than or equal to 84% of the data when ranked in ascending order. By using a sliding window that captures the most recent data, we ensure that the quantile model is dynamic and reflects the most current state of the data distribution. The more data that is available, the more accurate and fine-grained the quantiles become. If there are only 10 data points, computing percentiles is meaningless, and the best that can be done perhaps, is a median that divides the data into two sorted halves. A rough rule of thumb is that the number of quantiles is less than the number of samples divided by ten, i.e., to ensure that there are at least ten data points for every quantile. If there are millions of data points, quantiles can be computed at greater granularity, and with a greater confidence. As shown in FIG. 2G, the dynamic quantile model computes an extreme quantile threshold 251, which may, for example, be a 95th percentile of the deviation of density of a super alert hotspot from the expected density of the hotspot, as dictated by the super model that generates the super alerts. From among the super alerts 252 that exceed this threshold (illustrated by asterisks), the system further imposes conditions of recency, and identifies only those that occurred recently enough to warrant action. Once the system tags a super alert, the super alert will remain tagged unless additional late-arriving data causes the state to alter. Because of this, running a filter for super alerts could net problems that potentially occurred a few hours prior and could have either been remedied or ignored because the problem was not worth addressing. To minimize this flapping condition, the system ignores data arriving more than an hour late. The data is collected and stored for completeness, but is not used by the alarming pipeline. In either case, stale super alerts that have already been flagged should not generate an alert. Note that this is a configurable parameter. The first asterisk ceases to be a smart alert once it becomes stale, e.g., after thirty minutes.

Furthermore, the system identifies all the underlying super alerts that support this smart alert to generate an explanatory description that could make the smart alert actionable. FIG. 2H is a diagram that illustrates an example of a smart alert and the individual lower-level alerts that contributed to the smart alert. The nodes on the right represent lowest-level super alerts, e.g., alerts generated for a specific metric. The alerts in the middle column are higher-level super alerts, either at a compute component (svc_pod) or rolled-up metric level (svc_metric) level. The alert on the left is a smart alert 255 that the system generates and pushes to downstream systems. Sometimes an alert condition is not detected at the lowest level, because the individual signals are not strong enough, but when rolled up there is enough signal to warrant generating an alert (e.g., the svc_pod alert 256 in the middle column, second from the bottom that has to edge to the right). The labels in these nodes include the application ID, the timestamp of the alert, and the individual assets represented. A value of ALL indicates that the alert is a rollup of all the underlying assets.

Previous alerting systems focused on individual alerts and reducing the number of false positives. Some systems reduced the number of alerts by suppressing alerts that were close together in time. While this approach might be effective for monitoring a limited number of streams, the approach fails when monitoring a massive number of streams which would generate a large number of alerts by sheer statistical chance, at random points in time, in random series.

The disclosed system focuses on significant hotspots of anomalies—an “unusual” density of alerts that are concentrated in time and/or affect a multiple set of streams. Unusual is defined with reference to recent history so that density of anomalies has to be significant compared to the constantly evolving historical norm, not based on some fixed threshold. The system identifies unusually long or short runs of anomalies, as well as unusual co-occurrence of anomalies across multiple streams.

Furthermore, by imposing additional constraints (learned from historical data) on recency and extremeness of the density, the system ensures that the alerts are relevant and actionable. This is a unique aspect to the disclosed alerting system and provides operators with alerts that are significant since they affect multiple objects (streams) and are not one-off and not remediated by the AI-based self-correcting solutions baked into the system. Furthermore, descriptions of the objects aid the system to locate the alert in the domain space (e.g., cloud components) and the hierarchy of the alerts in the hotspot could potentially point to the propagation of the anomalies.

While for purposes of simplicity of explanation, the respective processes are shown and described as a series of blocks in FIGS. 2B-2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In complex systems that are monitored by many sensors that produce numerous data streams of measured values, the number of detected anomalies can be overwhelming. An anomaly may simply be a statistical coincidence, but when there are thousands of data streams (or more) and large amounts of data, the sheer number of anomalies can lead to users or operators missing or ignoring alerts. While identifying significant groups of anomalies and/or alerts, such as smart alerts (which may be complex and include many anomalies), reduces the outputs to a manageable number of alerts, providing users or operators with an interactive mechanism to explore related anomalies and/or alerts (or multi-layered alerts) over numerous data streams and across various dimensions can further aid root cause analyses and identification of causal events.

FIG. 2I is a block diagram illustrating an example, non-limiting embodiment of an interactive visualization and exploration system 270 and an anomaly detection and alerting system 272, functioning within the communications network 100 of FIG. 1 in accordance with various aspects described herein. As shown in FIG. 2I, the interactive visualization and exploration system 270 may be communicatively coupled with the anomaly detection and alerting system 272 (e.g., over a network (not shown)). In some embodiments, the interactive visualization and exploration system 270 may include, or may be included in, the anomaly detection and alerting system 272. The anomaly detection and alerting system 272 may include one or more on-premises and/or cloud-based machines (e.g., virtual machine(s) (VMs)) configured or deployed to process data streams associated with various entities/components (e.g., machines, applications, etc.), and execute and maintain anomaly detection and alerting models. In one or more embodiments, the anomaly detection and alerting system 272 may be configured to monitor complex systems, such as, for example, applications and systems on a cloud environment, data lakes, data centers, distributed content delivery networks, data-intensive ML applications over large and diverse data sources, and so on. In various embodiments, the anomaly detection and alerting system 272 may be similar to, may be the same as, or may otherwise correspond to any of the example anomaly detection and alerting systems (e.g., where stream processing is decoupled from anomaly detection and alerting model maintenance) set forth in co-pending U.S. patent application Ser. No. 17/717,369, entitled “SYSTEM AND METHOD FOR CLOUD-BASED ANOMALY DETECTION AND ALERTING FOR STREAMING DATA,” filed on Apr. 11, 2022, which is incorporated herein by reference in its entirety.

In one or more embodiments, the interactive visualization and exploration system 270 may be implemented as a user interface (or dashboard) application functioning as a frontend of the anomaly detection and alerting system 272. For instance, the interactive visualization and exploration system 270 may be implemented as a web application that is accessible via an app or a web browser.

The interactive visualization and exploration system 270 may be configured to facilitate visualization and exploration of a dataset of measured data and/or alerts (super alerts and/or smart alerts) in any suitable context or domain, where the alerts may be “rolled up” to particular dimensions of a hierarchical structure. A dataset may include continuous streams of measurements/alerts that can be aggregated on the different dimensions. As an example, in the hierarchy described above with respect to FIG. 2A, alerts may be aggregated based on service, machine, type of measurement, time, and so on. For instance, measurements, such as CPU load, memory usage, etc., may be made at the Container level under Service 1. Here, rolling up for Service 1 may include all of the alerts detected from data streams relating to Containers 1 and 2. As another example, aggregation at the Host level for Host 2 may relate to metrics observed in Containers 2 and 3, where alerting may be performed on an aggregation of those metrics. In any case, the available aggregations for a dataset may form a (e.g., multi-dimensional) lattice, where nodes of the lattice may correspond to levels of aggregation, and edges of the lattice may correspond to dimensions that need to be specified or traversed in order to reach an aggregation.

In exemplary embodiments, the interactive visualization and exploration system 270 may be configured to operate on a given dataset by first defining or constructing a lattice that is based on a hierarchy associated with the dataset and relationships between measurements from which alerts are derived. In various embodiments, the dataset may be arranged or partitioned according to its hierarchy. FIG. 2J shows example levels/sub-levels of one or more hierarchies in accordance with various aspects described herein. As shown in FIG. 2J, consumer mobile device prevalence/usage data may be partitioned by market region. Here, levels and sub-levels (e.g., 274a, 274b, 274c) in the associated hierarchy may include, for example, market region, device/phone type, plan, operating system, and so on. As another example, in the hierarchy described above with respect to FIG. 2A, a corresponding dataset may be partitioned by Application ID. In one or more embodiments, a dataset may also be segmented into predefined time intervals or windows (e.g., 274d of FIG. 2J), such as time windows of an hour, a day, a week, a month, and so on. In certain embodiments, the time windows may overlap, e.g., to display any 24-hour period, etc.

In exemplary embodiments, the interactive visualization and exploration system 270 may be configured to present a heatmap for navigating the lattice. Different portions of the heatmap may correspond to different subspaces of the lattice, where a concentration or density of alerts (or detected anomalies) in a given subspace may be indicated according to a visual scheme. In certain embodiments, the visual scheme may be color-based (e.g., by hue and/or intensity), where, for instance, a brighter color (e.g., bright yellow, etc.) may indicate a higher density of alerts and a darker color (e.g., dark blue, etc.) may indicate a lower density of alerts, although any suitable visual scheme may be used. In this way, the various subspaces of the lattice may be visually distinguishable in the heatmap according to the respective concentrations of anomalies/alerts in those subspaces. FIG. 2L shows an example multi-dimensional heatmap 276 of a user interface (or dashboard) provided by the interactive visualization and exploration system 270 in accordance with various aspects described herein. As shown in FIG. 2L, a density indicator 276i may inform the visual scheme employed in the heatmap 276, by identifying the range of concentrations of anomalies/alerts (or quantities of alerts, such as from 0 to 15 alerts)—in subspaces of the lattice that are represented by cells 276c in the heatmap 276—and their corresponding visual representations (here, e.g., colors).

Exemplary embodiments of the interactive visualization and exploration system 270 may support navigation of, or “drilling down” into, different subspaces of a lattice of categorical dimensions in a compact way, which is especially useful in cases where there are numerous dimensions (and numerous dimensional values) in the corresponding hierarchy. Drilling down into the lattice, or otherwise traversing the various categorical dimensions, to zoom into a smaller subspace of the lattice (or to zoom out to a larger subspace of the lattice), may be performed by selecting/adjusting values of the categorical dimensions (or ranges of the different dimensions) as well as via interaction with the heatmap 276 and/or time series charts, as described in more detail below.

User exploration of anomalies/alerts using the interactive visualization and exploration system 270 may begin by selecting a dataset, which may correspond to a predefined lattice of aggregations, as described above. In various embodiments, a dataset partition may be selected and/or a time window of interest may be chosen (e.g., a particular day when there was a known application outage, a month where an event occurred which affected subscriber behavior, etc.). Filtering by way of timestamps or ranges of timestamps enables a user to focus in on specific super or smart alert(s). In alternate embodiments, the interactive visualization and exploration system 270 may (e.g., by default or based on prior user setting) select a (e.g., arbitrary) partition for the dataset and/or the most recent available time window. In one or more embodiments, the interactive visualization and exploration system 270 may enable selection of dimensions (e.g., device, etc.) in different orders depending on the hierarchical structure.

In various embodiments, the interactive visualization and exploration system 270 may enable selection of (e.g., some of the) dimensions via drop down menus. In a case where there are multiple selectable dimensions for a first traversal, the interactive visualization and exploration system 270 may permit dimension selection via a first drop-down menu (e.g., 274b in FIG. 2J), and a choice of values in a second drop-down menu (e.g., 274c in FIG. 2J). It is to be appreciated and understood that the interactive visualization and exploration system 270 may enable selection of dimension values in other ways, such as via lists, icons, and so on. Once a first dimension traversal is performed, the interactive visualization and exploration system 270 may (e.g., by default or based on prior user setting), select the “worst” choice for that dimension, which may be a value associated with the greatest number of associated (e.g., smart) alerts. It is to be appreciated and understood that other manners of implementation are possible. As some examples, the interactive visualization and exploration system 270 may (e.g., automatically or based on user input or setting) select a value or level of aggregation associated with the smallest number of associated (e.g., smart) alerts, a value or level of aggregation associated with the most recent alerts, etc.

In exemplary embodiments, the interactive visualization and exploration system 270 may (e.g., based upon user selection of a first dimension) present a time series chart that displays the density of alerts in the underlying dimensions, over time. A time series chart may be presented for any node in the lattice where an aggregation is defined. FIG. 2K depicts an example time series chart in accordance with various aspects described herein. As shown by reference number 275a, the time series chart may include a horizontal axis at ‘0’ value, and lines identifying the concentrations of any anomalies, super alerts, and/or smart alerts in the underlying dimensions, expressed as standardized residual versus time. Where there are super alerts at the current level of aggregation, they may be respectively identified as objects, such as dots of a certain shape, color, size, etc. on a line 275c, and where there are smart alerts (e.g., which may be the top N % of super alerts), they may be respectively identified as other objects, such as dots of another shape (e.g., asterisks), color, size, etc. on the line 275c. As depicted in FIG. 2K, the time series chart may include a line 275d that represents an average density of alerts across all time series for the aforementioned first dimension, which may help illuminate the various super alerts (e.g., those above the average density) that contributed to the smart alerts. As shown by reference number 275b, the interactive visualization and exploration system 270 may enable user selection (275e) of one or more alerts in the time series chart as part of facilitating alert exploration.

In exemplary embodiments, the interactive visualization and exploration system 270 may (e.g., based upon user selection of the aforementioned first dimension or based upon user selection of alert(s) in the time series chart) present the corresponding heatmap (e.g., heatmap 276 of FIG. 2L) representing the density of super/smart alerts across remaining dimensions (e.g., the remaining two dimensions) in the hierarchy. The interactive visualization and exploration system 270 may present the heatmap in any suitable location relative to the time series chart, such as, for example, adjacent to or below the time series chart. The heatmap may enable exploration of subspaces corresponding to these remaining dimensions, where alert density is of interest. This enables traversal of the lattice to subspaces thereof with large concentrations of anomalies/alerts, which can enable identification of how multi-layered (or multi-level) anomalies/alerts evolve over time as well as permit focused investigation into attributes that are shared by data streams with high densities of anomalies/alerts. In a case where the time series chart is constrained by a time range selection, the heatmap may present the density of super alerts within that time range. In a different case where the time series chart is not constrained by a time range selection, the heatmap may present the density of super alerts across an entire time window.

Each cell in the heatmap may correspond to alerts associated with the two remaining dimensions in the hierarchy. In exemplary embodiments, the interactive visualization and exploration system 270 may, based upon user selection of a cell in the heatmap (such as any cell 276c of heatmap 276), present an additional (or second) time series chart (e.g., below or adjacent to the heatmap 276). This second time series chart may correspond to an individual metric without aggregation, and may display the super alerts generated for the metric. In various embodiments, the second time series chart may always have the same number of super alerts as that indicated by (e.g., the color of) the selected heatmap cell, within a time range selected in the first time series chart (e.g., the first time series chart shown in FIG. 2K). If there is no time range selected for the first time series chart, then it is as if an entire time range is selected, and thus the selected heatmap cell may indicate the total number of super alerts shown in the entire second time series chart through the entire time range. The super alerts in the second time series chart may generally be a subset of the super alerts displayed in the first time series chart, although the number of super alerts displayed in the two time series charts within the time range may or may not be the same (for instance, while unlikely, there may, in some cases, be super alerts displayed in the second time series chart that are not displayed in the first time series chart).

In various embodiments, the heatmap may include an additional row and/or column corresponding to intermediate levels of aggregation in the lattice that may exist between the node/level displayed in the first time series chart (e.g., FIG. 2K) and the finest level of aggregation available. For example, in a case where aggregations are defined at “service-pod” and “service-gauge” levels, the heatmap may present a row labeled “All Pods” (which displays the alert density for each service-gauge across all service-pods), and a column labeled “All Gauges” (which displays the alert density for each service-pod across all service-gauges). Selection of any cells (e.g., 276h or 276q in FIG. 2L) in this row/column may result in selection of only one additional dimension, and may produce a time series chart (the aforementioned second time series chart) that is aggregated at the intermediate level.

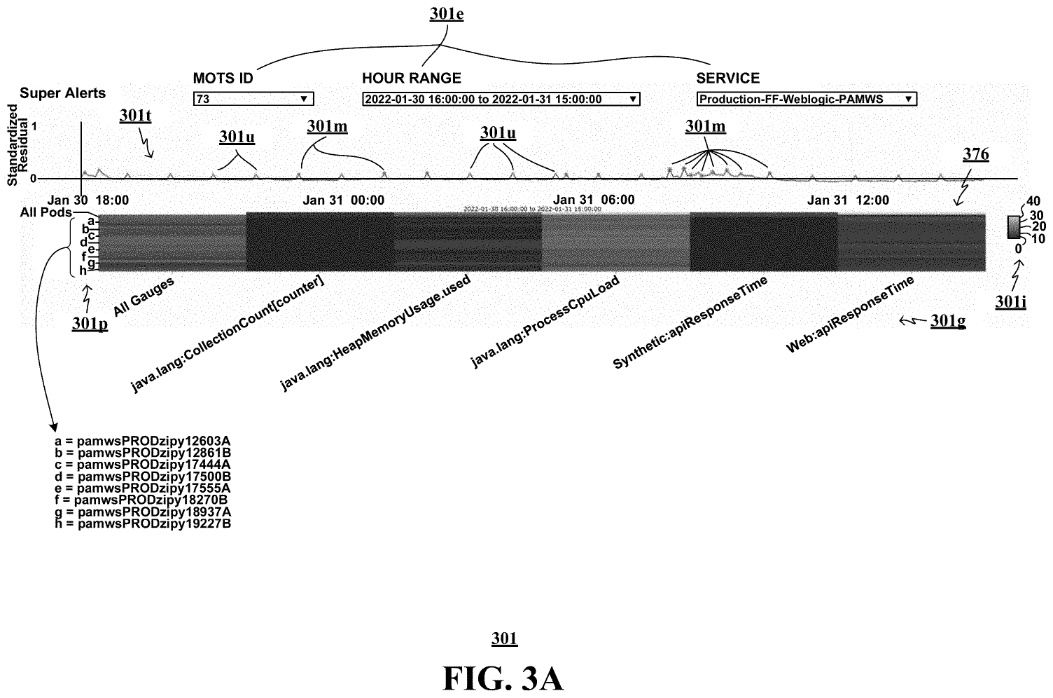

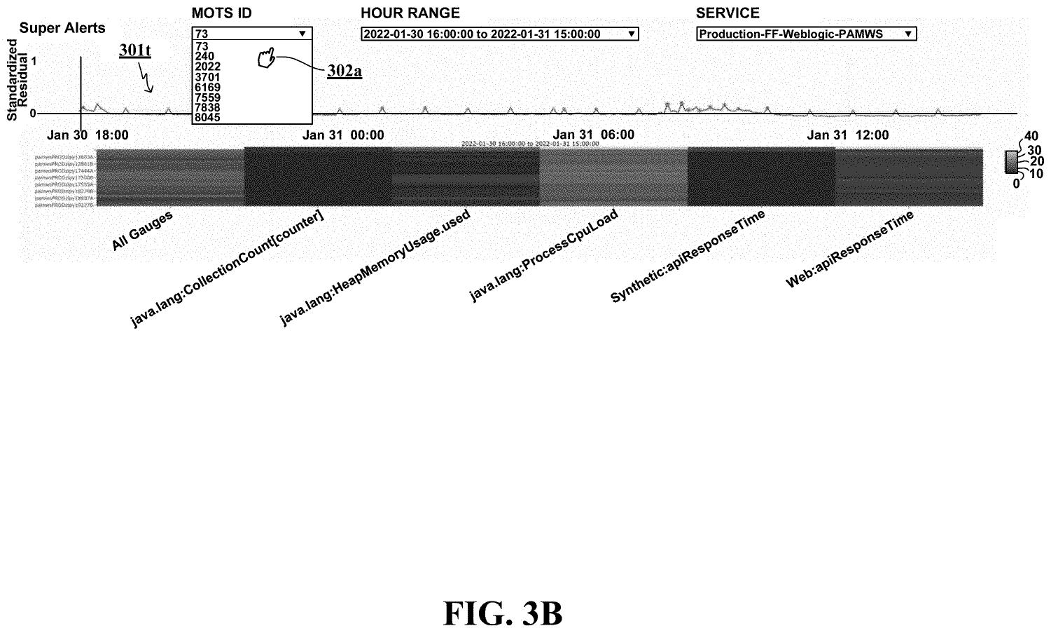

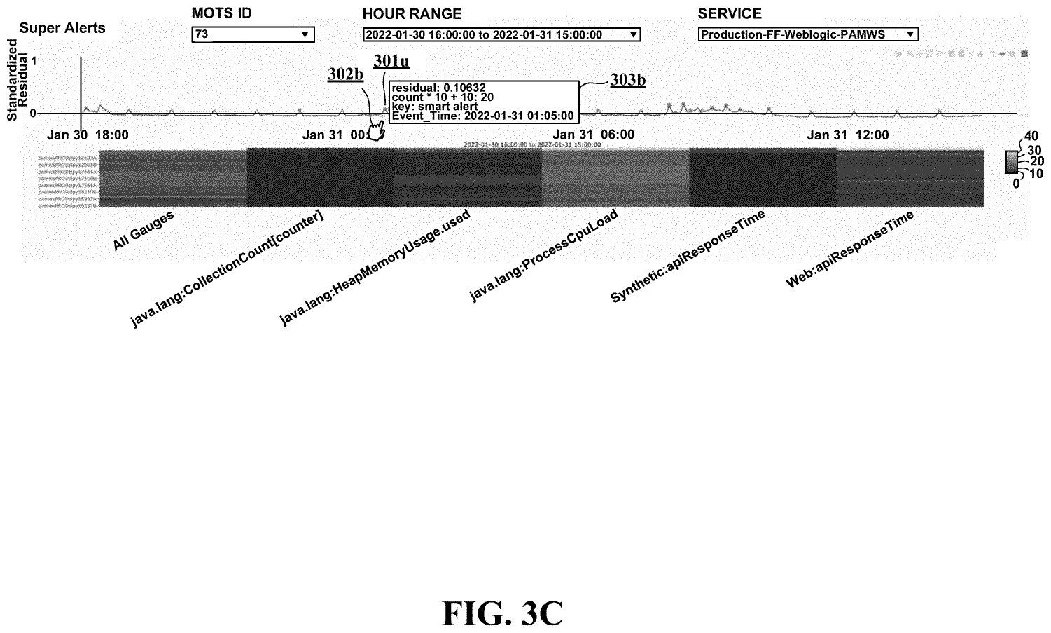

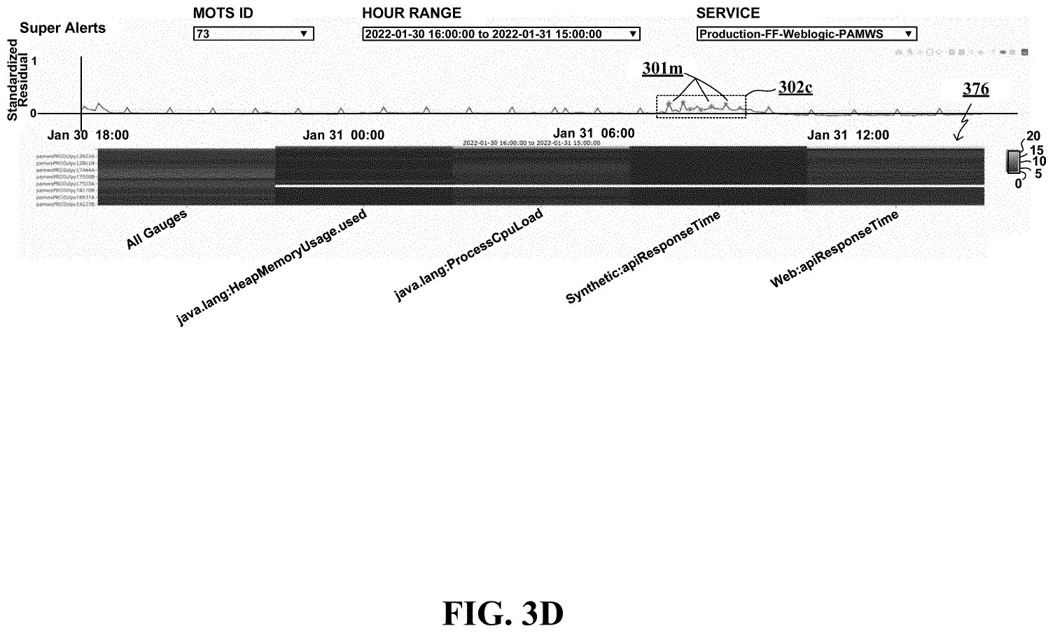

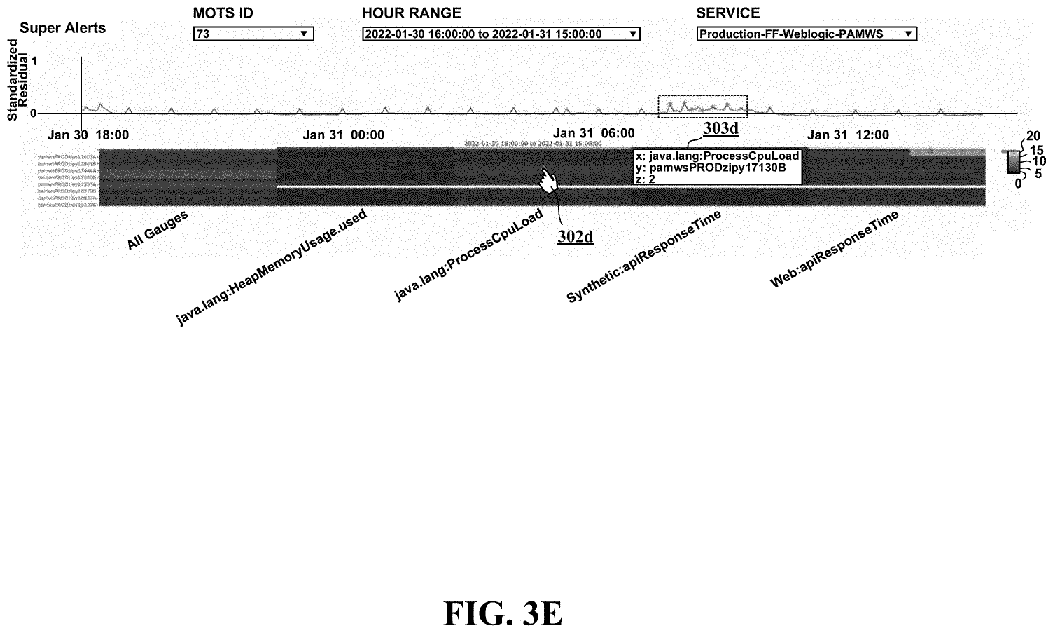

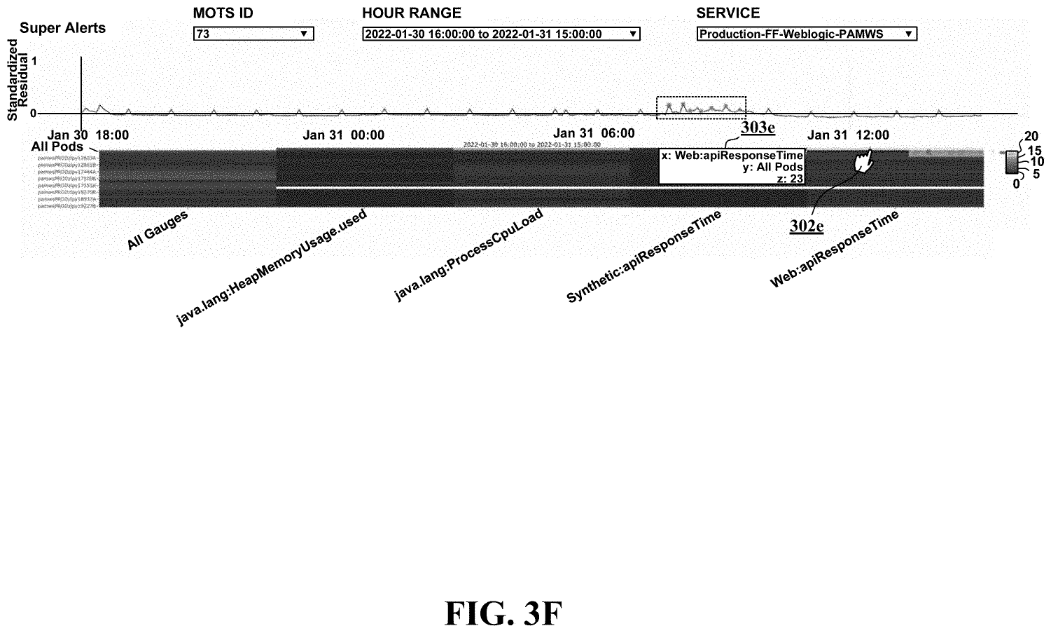

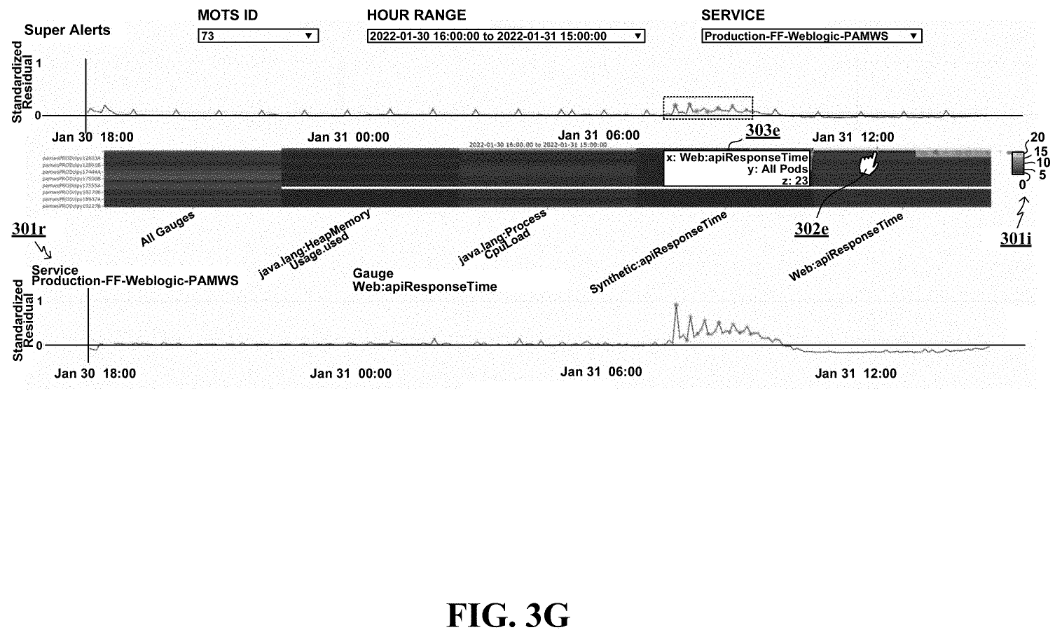

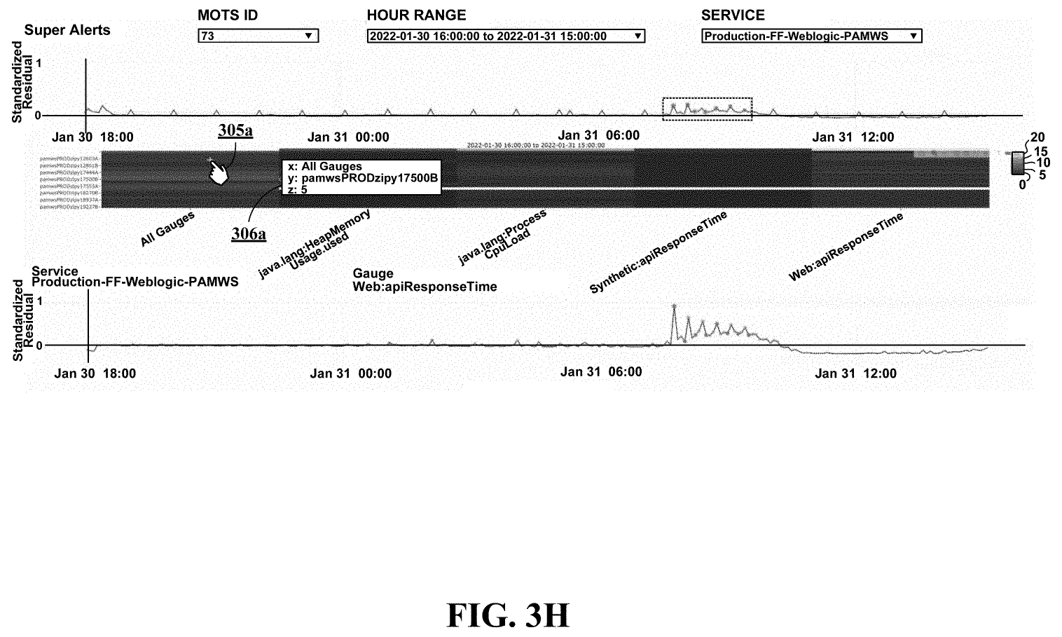

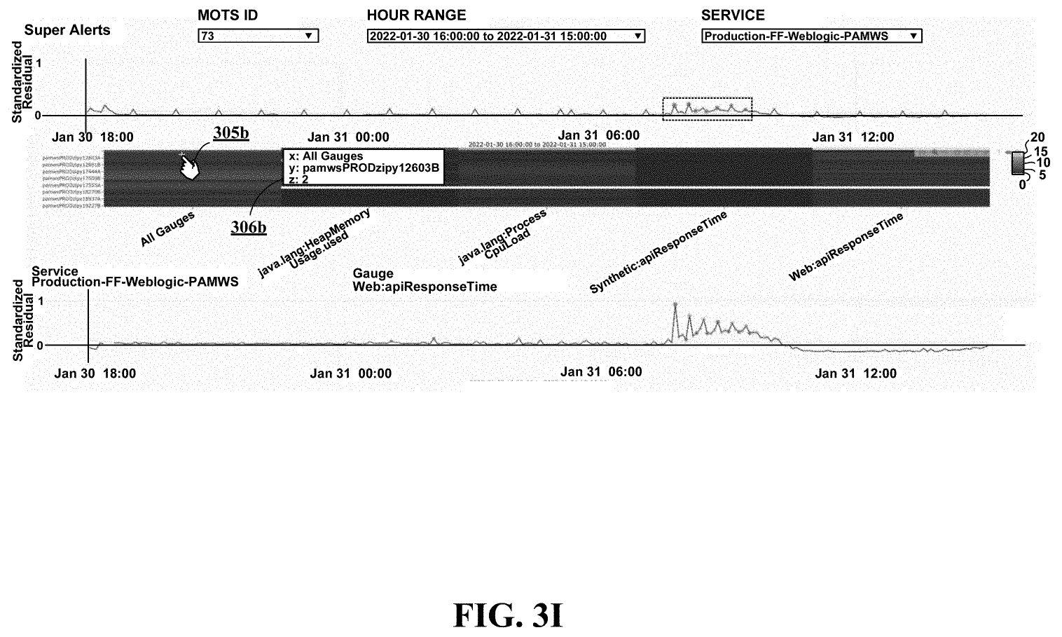

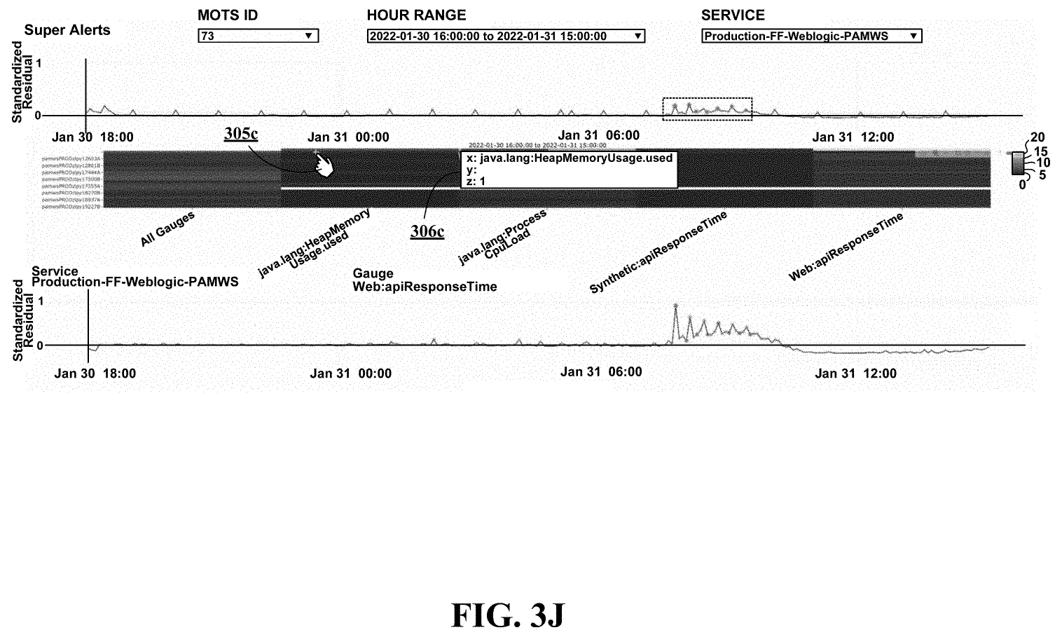

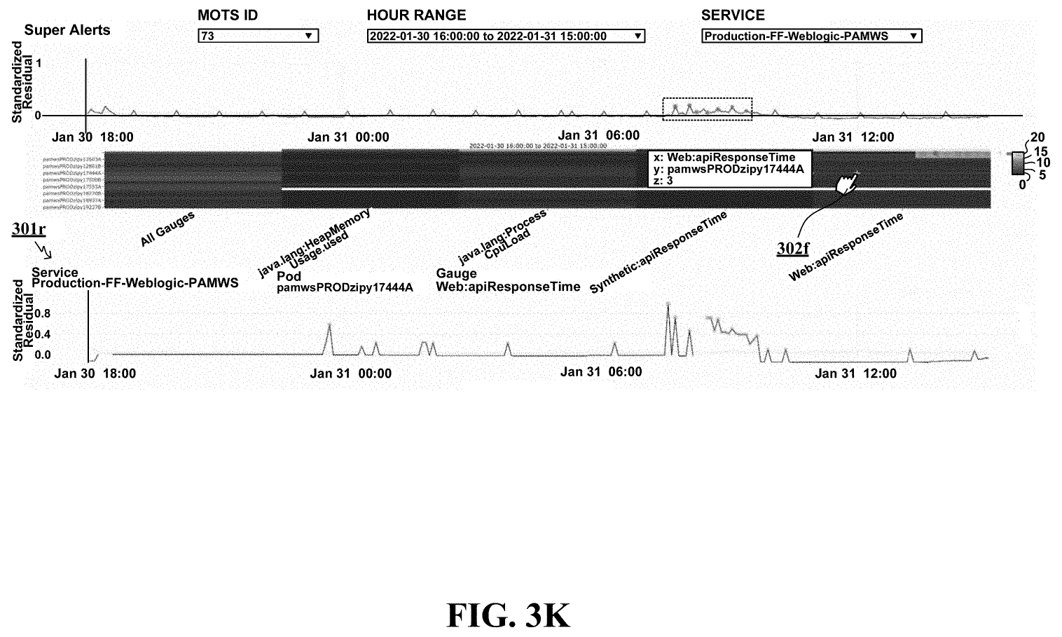

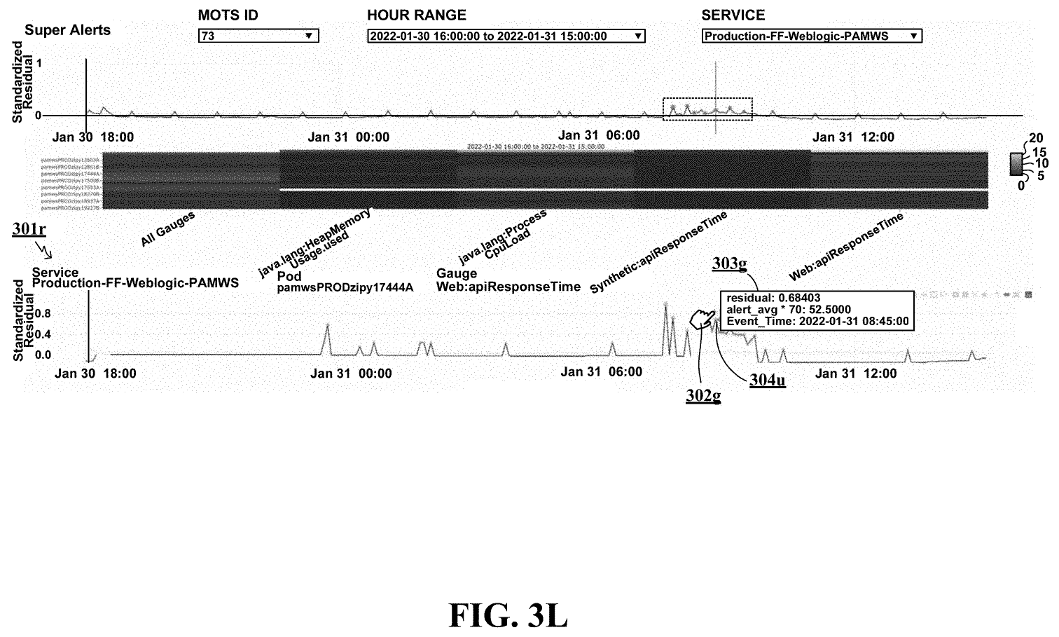

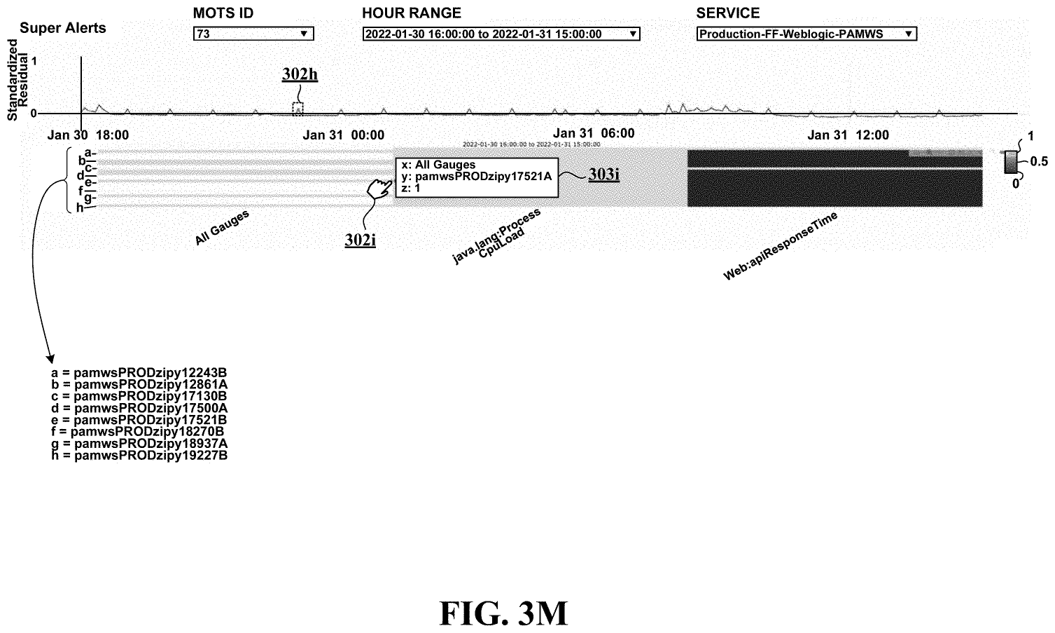

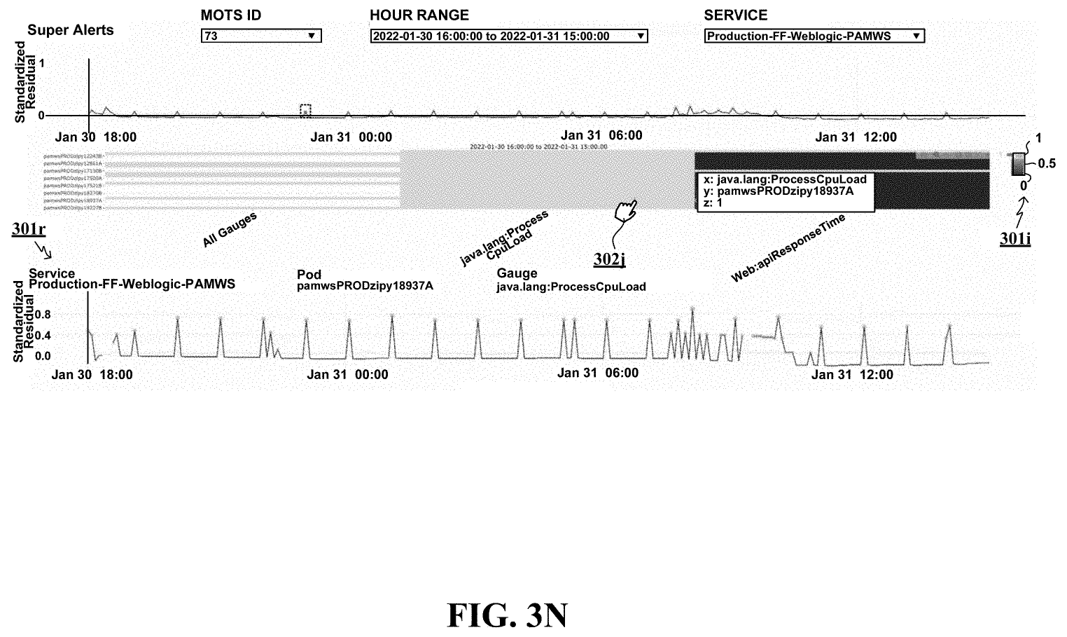

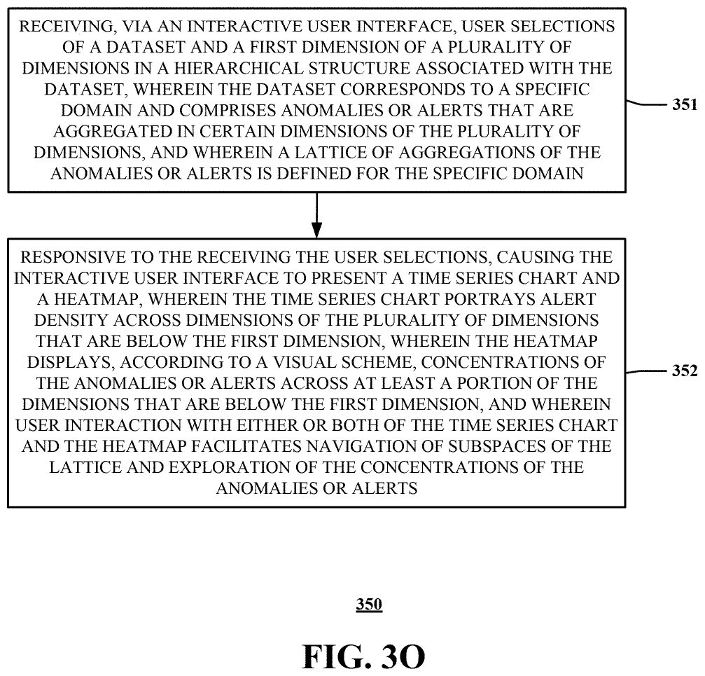

FIGS. 3A-3N show various views of an example user interface 301 presented by the interactive visualization and exploration system 270 of FIG. 2I, including a multi-dimensional heatmap 376 and time series charts 301t and 301r, in accordance with various aspects described herein. Some or all aspects of the heatmap 376 and time series charts 301t and 301r in FIGS. 3A-3N may be similar to, or may correspond to, various aspects of the heatmap and time series charts described above with respect to one or more of FIGS. 2I-2L.

Here, the example hierarchy relating to what is shown in FIGS. 3A-3N may be similar to, or may correspond to, that described above with respect to FIG. 2A, where a dataset may be grouped or partitioned by “application.” For instance, the interactive visualization and exploration system 270 may present alerts/anomalies relating to different applications running on different containers, where services may be provided via various containers 301p (e.g., some of which are shown as ‘a’ through ‘h’ in FIG. 3A) “underneath” them in the hierarchy, and measurements 301g may be made for those containers. Here, “pods” may represent containers, and “gauges” may represent measurements/metrics, and both may be the final two dimensions in the hierarchy. A pod may generally refer to a source or location (e.g., the “where”) a measurement is to be made, and a gauge may generally refer to a component/metric (e.g., the “what” that is) to be measured or monitored. It is to be appreciated and understood that the interactive visualization and exploration system 270 may be similarly employed for datasets in other domains or contexts or in other hierarchies.

The user interface 301 may enable selection of one or more dimensions in the hierarchy via drop-down menus 301e. The user interface 301 may also enable selection of one or more dimensions via selectable cells in the heatmap 376. In exemplary embodiments, different portions/cells of the heatmap 376 may correspond to different subspaces of a lattice of aggregations for the hierarchy of FIG. 2A, where a concentration or density of alerts (or detected anomalies) in a given subspace of the lattice may be indicated according to a visual scheme—here, a color-based scheme (e.g., density indicator 301i of FIG. 3A)—similar to that described above with respect to the heatmap 276 of FIG. 2L. Drilling down into the lattice, or otherwise traversing the various categorical dimensions, to zoom into a small subspace of the lattice (or to zoom out to a larger subspace of the lattice), may be performed by selecting/adjusting values of the categorical dimensions (or ranges of the different dimensions) as well as via interaction with the heatmap 376 and/or the time series chart 301t. Interactive traversal over the heatmap 376 and/or the time series chart 301t facilitates identification of subspaces with large concentrations of anomalies/alerts, and can reveal the evolution of anomalies/alerts over time as well as the attributes that are shared by data streams with high concentrations of anomalies, super alerts 301u, or smart alerts 301m.

As shown in FIG. 3B, the user interface 301 may enable user selection (302a) of different application IDs (e.g., labeled MOTS ID), and may, based upon user selection of a particular application ID, cause the user interface 301 to present a time series chart 301t and a heatmap 376 that represent concentrations of alerts/anomalies in various underlying dimensions. The user interface 301 may also enable filtering/selection (via individual timestamps or ranges of timestamps) in the time dimension as well as one or more other aggregation levels, such as the “Service” level, to enable narrowing in on, for instance, a specific super alert in a group of super alerts.

In one or more embodiments, the user interface 301 may enable user selection of one or more alerts identified in the time series chart 301t. For example, as shown in FIG. 3C, selection (302b) of a super alert 301u (e.g., via hovering of a pointer, clicking, and so on) may cause the user interface 301 to present data 303b regarding that alert. As another example, as shown in FIG. 3D, user selection (302c) of multiple alerts (e.g., super alerts 301u) in the time series chart 301t (e.g., via a point-and-drag action or the like), may cause the user interface 301 to update the heatmap 376 accordingly so as to convey what contributed to those selected alerts.

As briefly described above, the user interface 301 may also enable user selection of one or more cells in the heatmap 376. As depicted in FIG. 3E, selection (302d) of a cell in the heatmap 376 may cause the user interface 301 to present data (303d) regarding that cell.

In certain embodiments, the interactive visualization and exploration system 270 may (e.g., automatically or based on user input or setting) cause the user interface 301 to present the time series chart 301t and the heatmap 376 according to a value or level of aggregation associated with the greatest number of associated (e.g., smart) alerts 301m. For instance, as shown in FIG. 3A, the user interface 301 may present the time series chart 301t and the heatmap 376 for the Service “Production-FF-Weblogic-PAMWS” based on that Service value being associated with the greatest number of smart alerts 301m. It is to be appreciated and understood that other manners of implementation are possible. As some examples, the interactive visualization and exploration system 270 may (e.g., automatically or based on user input or setting) cause the user interface 301 to present the time series chart 301t and the heatmap 376 according to a value or level of aggregation associated with the smallest number of associated smart alerts 301m, according to a value or level of aggregation associated with the most recent smart alerts 301m, etc.

To facilitate efficient user identification of potential underlying issues across all pods and/or across all gauges, the heatmap 376 provides a user selectable (e.g., top) row and a user selectable (e.g., leftmost) column for respective selection of “All Pods” and “All Gauges.” FIG. 3F depicts a user selection 302e (all pods for the gauge “Web:apiResponseTime”) and corresponding presentation of data 303e (showing that z=23 alerts were generated across all pods for this gauge), and FIG. 3G shows an updated user interface 301 that includes another time series chart 301r (showing standardized residual or concentration of anomalies/alerts over time) corresponding to that selection 302e. In various embodiments, the time series chart 301r may show the various alerts/anomalies that contributed to alerts in the level (e.g., here, the Service level) above.

In certain embodiments, the user interface 301 may distinguish between simply scanning over a cell in the heatmap 376 and actual selection of the cell in the heatmap 376. For instance, as shown in FIGS. 3H-3J, hovering over (but not actually selecting) a cell (e.g., 305a, 305b, 305c) may cause the user interface 301 to simply present corresponding data therefor (306a, 306b, 306c), but not present/update the time series chart 301r accordingly, whereas actual selection of (e.g., clicking or pointing on) the cell may result in the user interface 301 presenting/updating the time series chart 301r for that selection (as described above with respect to FIG. 3G). In alternate embodiments, merely hovering over a cell may cause the user interface 301 to both present the corresponding data as well as present/update the time series chart 301r.

In various embodiments, the user interface 301 may enable user selection of one or more alerts identified in the time series chart 301r. For example, as shown in FIG. 3K, selection (302f) of a cell may result in presentation/update of the time series chart 301r, and as shown in FIG. 3L, selection (302g) of an alert 304u (e.g., via hovering of a pointer, clicking, or the like) in the time series chart 301r may cause the user interface 301 to present data (303g) regarding that alert.

FIGS. 3M and 3N show additional examples of user interaction with the heatmap 376 in accordance with various aspects described herein. With reference to FIG. 3M, user selection (302h) of a single super/smart alert in the time series chart 301t, may cause the user interface 301 to update the heatmap 376 (as well as the density indicator 301i) accordingly so as to convey what contributed to the selected alert—e.g., here, all of the pods and gauges that also had an alert at the same time of the selected alert. As depicted in FIG. 3M, selection (302i) of a subspace or cell in the heatmap 376 may cause the user interface 301 to present data (303i) regarding that subspace or cell. As shown in FIG. 3N, selection (302j) of a certain subspace/cell of interest may cause the user interface 301 to present the time series chart 301r, which identifies the particular pod and gauge that contributed to the alert of interest.

Thus, the interactive visualization and exploration system 270 enables exploration of alerts/anomalies (including identification of “hotspots” (of anomalies) as well as the pods associated with such anomalies) in an intuitive way, and facilitates overall determination of root causes of events. Since super alerts and smart alerts may correspond to a high density of alerts/anomalies at lower levels of aggregation (i.e., they may be aggregated for lower layers, levels, or dimensions in a hierarchy), the interactive visualization and exploration system 270 offers an effective way to identify the underlying reason for a given (e.g., super) alert that is triggered at lower levels.

In various embodiments, the interactive visualization and exploration system 270 may include, or may be configured to employ, one or more machine learning (ML) algorithms to monitor and analyze user behavior with respect to the user interface, and utilize learned information to improve user experience. For instance, in one or more embodiments, the ML algorithm(s) may identify common explorations paths in a multi-dimensional lattice (e.g., by observing point-and-click patterns, navigation among different pods and gauges, and so on) and utilize findings as a proxy for what a user finds important or interesting. The ML algorithm(s) may, based on learned information, provide recommended explorations steps or paths (e.g., series of interaction steps or the like) to the user (or other users) to further facilitate interactive exploration of anomalies/alerts.

Although various aspects of the interactive visualization and exploration system 270 is described herein as being visually presented, it is to be appreciated and understood that presentation of multi-layered alerts/anomalies can be presented in any suitable manner, such as, for example, audibly, haptically, and/or the like. Additionally, although various aspects of the interactive visualization and exploration system 270 is described herein as involving use of a pointing mechanism to hover, click, or select items, it is also to be appreciated and understood that user selections described herein, can be performed in any suitable manner, such as, for example, via a touch screen display, via a voice command, via a gesture, and/or the like.

It is further to be appreciated and understood that, although one or more of FIGS. 2I-2L and 3A-3N are described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein.

FIG. 3O depicts an illustrative embodiment of a method 350 in accordance with various aspects described herein. In some embodiments, one or more process blocks of FIG. 3O can be performed by an interactive visualization and exploration system, such as the interactive visualization and exploration system 270. In some embodiments, one or more process blocks of FIG. 3O may be performed by another device or a group of devices separate from or including the interactive visualization and exploration system 270.

At 351, the method can include receiving, via an interactive user interface, user selections of a dataset and a first dimension of a plurality of dimensions in a hierarchical structure associated with the dataset, wherein the dataset corresponds to a specific domain and comprises anomalies or alerts that are aggregated in certain dimensions of the plurality of dimensions, and wherein a lattice of aggregations of the anomalies or alerts is defined for the specific domain. For example, the interactive visualization and exploration system 270 can, similar to that described elsewhere herein, perform operations that include receiving, via an interactive user interface, user selections of a dataset and a first dimension of a plurality of dimensions in a hierarchical structure associated with the dataset, wherein the dataset corresponds to a specific domain and comprises anomalies or alerts that are aggregated in certain dimensions of the plurality of dimensions, and wherein a lattice of aggregations of the anomalies or alerts is defined for the specific domain.

At 352, the method can include, responsive to the receiving the user selections, causing the interactive user interface to present a time series chart and a heatmap, wherein the time series chart portrays alert density across dimensions of the plurality of dimensions that are below the first dimension, wherein the heatmap displays, according to a visual scheme, concentrations of the anomalies or alerts across at least a portion of the dimensions that are below the first dimension, and wherein user interaction with either or both of the time series chart and the heatmap facilitates navigation of subspaces of the lattice and exploration of the concentrations of the anomalies or alerts. For example, the interactive visualization and exploration system 270 can, similar to that described elsewhere herein, perform operations that include, responsive to the receiving the user selections, causing the interactive user interface to present a time series chart and a heatmap, wherein the time series chart portrays alert density across dimensions of the plurality of dimensions that are below the first dimension, wherein the heatmap displays, according to a visual scheme, concentrations of the anomalies or alerts across at least a portion of the dimensions that are below the first dimension, and wherein user interaction with either or both of the time series chart and the heatmap facilitates navigation of subspaces of the lattice and exploration of the concentrations of the anomalies or alerts.

In some implementations of these embodiments, the heatmap displays the concentrations of the anomalies or alerts across a remaining two dimensions of the plurality of dimensions. In some implementations of these embodiments, the heatmap comprises a plurality of cells that each corresponds to the remaining two dimensions of the plurality of dimensions. In some implementations of these embodiments, the operations further comprise receiving, via the interactive user interface, a user selection of a given cell of the plurality of cells, and causing, based on the receiving the user selection, the interactive user interface to present a second time series chart that portrays an individual metric without aggregation. In some implementations of these embodiments, the remaining two dimensions correspond to pods and gauges.

In some implementations of these embodiments, the lattice of aggregations comprises nodes and edges, where each of the nodes corresponds to a level of the aggregations, and where each of the edges corresponds to a particular dimension that needs to be specified to arrive at a particular aggregation.

In some implementations of these embodiments, the visual scheme comprises a color-based scheme in which different colors correspond to different concentrations of anomalies or alerts.

In some implementations of these embodiments, the operations further comprise receiving a user selection of a time window, where the causing the interactive user interface to present the time series chart and the heatmap is in accordance with the time window.

In some implementations of these embodiments, the user interaction includes selections of one or more alerts portrayed in the time series chart, selections of one or more portions of the heatmap, or a combination thereof to zoom in to or zoom out to various subspaces of the lattice.

In some implementations of these embodiments, the user interaction includes adjustments to ranges of dimensions to modify dimensions of an explored subspace of the lattice.

In some implementations of these embodiments, the alerts are generated from monitored data streams provided by an anomaly detection and alerting system.

In some implementations of these embodiments, the anomaly detection and alerting system is configured to monitor applications or systems on a cloud environment, one or more data lakes, one or more data centers, one or more distributed content delivery networks, one or more machine learning (ML) applications associated with one or more data sources, or a combination thereof.

In some implementations of these embodiments, the dataset is partitioned based on the hierarchical structure.

While for purposes of simplicity of explanation, the respective processes are shown and described as a series of blocks in FIG. 3O, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

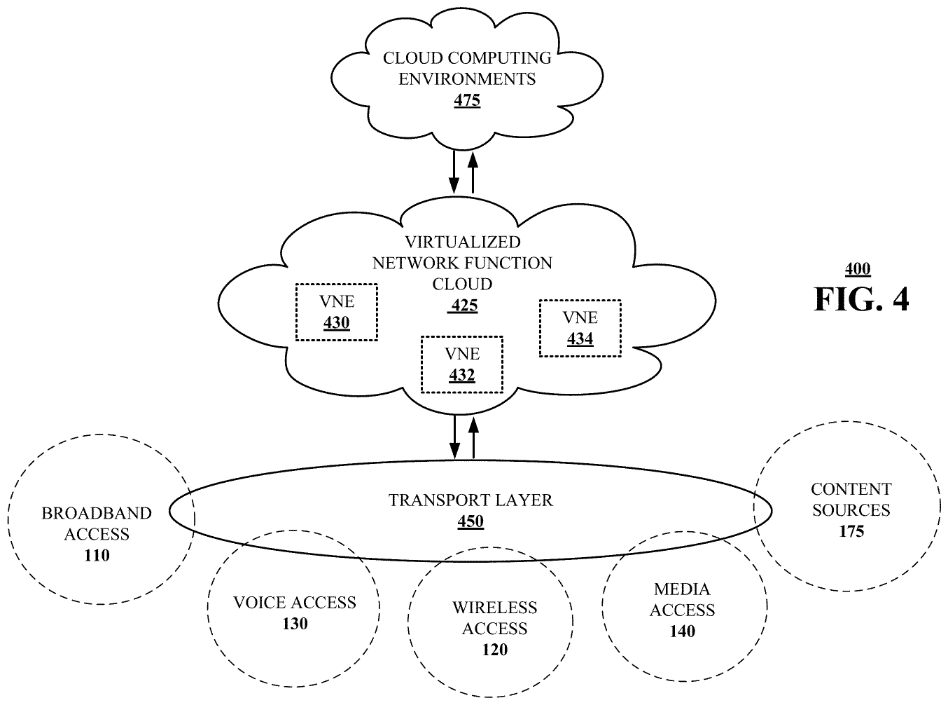

Referring now to FIG. 4, a block diagram 400 is shown illustrating an example, non-limiting embodiment of a virtualized communications network in accordance with various aspects described herein. In particular, a virtualized communications network is presented that can be used to implement some or all of the subsystems and functions of system 100, the subsystems and functions of system 270, and method 350 presented in FIGS. 1, 2I-2L, and 3A-3O. For example, virtualized communications network 400 can facilitate, in whole or in part, interactive visualization and exploration of multi-layer alerts for effective anomaly management.

In particular, a cloud networking architecture is shown that leverages cloud technologies and supports rapid innovation and scalability via a transport layer 450, a virtualized network function cloud 425 and/or one or more cloud computing environments 475. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communications network employs virtual network elements (VNEs) 430, 432, 434, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 430 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 450 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 430, 432 or 434. These network elements can be included in transport layer 450.

The virtualized network function cloud 425 interfaces with the transport layer 450 to provide the VNEs 430, 432, 434, etc. to provide specific NFVs. In particular, the virtualized network function cloud 425 leverages cloud operations, applications, and architectures to support networking workloads. The virtualized network elements 430, 432 and 434 can employ network function software that provides either a one-for-one mapping of traditional network element function or alternately some combination of network functions designed for cloud computing. For example, VNEs 430, 432 and 434 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 430, 432, 434, etc. can be instantiated and managed using an orchestration approach similar to those used in cloud compute services.

The cloud computing environments 475 can interface with the virtualized network function cloud 425 via APIs that expose functional capabilities of the VNEs 430, 432, 434, etc. to provide the flexible and expanded capabilities to the virtualized network function cloud 425. In particular, network workloads may have applications distributed across the virtualized network function cloud 425 and cloud computing environment 475 and in the commercial cloud, or might simply orchestrate workloads supported entirely in NFV infrastructure from these third party locations.

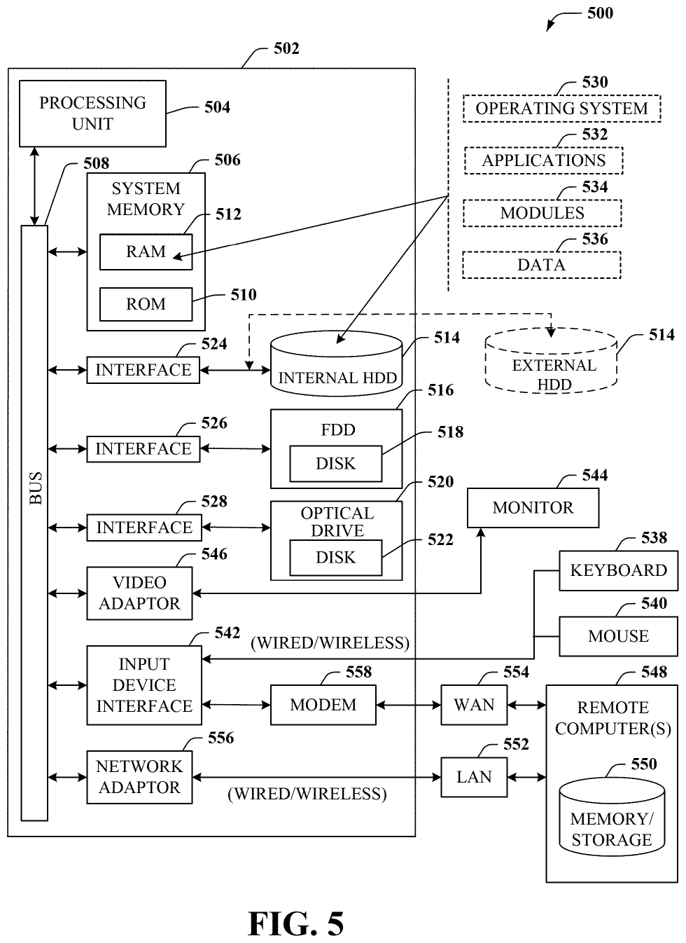

Turning now to FIG. 5, there is illustrated a block diagram of a computing environment in accordance with various aspects described herein. In order to provide additional context for various embodiments of the embodiments described herein, FIG. 5 and the following discussion are intended to provide a brief, general description of a suitable computing environment 500 in which the various embodiments of the subject disclosure can be implemented. In particular, computing environment 500 can be used in the implementation of network elements 150, 152, 154, 156, access terminal 112, base station or access point 122, switching device 132, media terminal 142, and/or VNEs 430, 432, 434, etc. Each of these devices can be implemented via computer-executable instructions that can run on one or more computers, and/or in combination with other program modules and/or as a combination of hardware and software. For example, computing environment 500 can facilitate, in whole or in part, interactive visualization and exploration of multi-layer alerts for effective anomaly management.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 5, the example environment can comprise a computer 502, the computer 502 comprising a processing unit 504, a system memory 506 and a system bus 508. The system bus 508 couples system components including, but not limited to, the system memory 506 to the processing unit 504. The processing unit 504 can be any of various commercially available processors. Dual microprocessors and other multiprocessor architectures can also be employed as the processing unit 504.

The system bus 508 can be any of several types of bus structure that can further interconnect to a memory bus (with or without a memory controller), a peripheral bus, and a local bus using any of a variety of commercially available bus architectures. The system memory 506 comprises ROM 510 and RAM 512. A basic input/output system (BIOS) can be stored in a non-volatile memory such as ROM, erasable programmable read only memory (EPROM), EEPROM, which BIOS contains the basic routines that help to transfer information between elements within the computer 502, such as during startup. The RAM 512 can also comprise a high-speed RAM such as static RAM for caching data.

The computer 502 further comprises an internal hard disk drive (HDD) 514 (e.g., EIDE, SATA), which internal HDD 514 can also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high capacity optical media such as the DVD). The HDD 514, magnetic FDD 516 and optical disk drive 520 can be connected to the system bus 508 by a hard disk drive interface 524, a magnetic disk drive interface 526 and an optical drive interface 528, respectively. The hard disk drive interface 524 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 502, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 512, comprising an operating system 530, one or more application programs 532, other program modules 534 and program data 536. All or portions of the operating system, applications, modules, and/or data can also be cached in the RAM 512. The systems and methods described herein can be implemented utilizing various commercially available operating systems or combinations of operating systems.

A user can enter commands and information into the computer 502 through one or more wired/wireless input devices, e.g., a keyboard 538 and a pointing device, such as a mouse 540. Other input devices (not shown) can comprise a microphone, an infrared (IR) remote control, a joystick, a game pad, a stylus pen, touch screen or the like. These and other input devices are often connected to the processing unit 504 through an input device interface 542 that can be coupled to the system bus 508, but can be connected by other interfaces, such as a parallel port, an IEEE 1394 serial port, a game port, a universal serial bus (USB) port, an IR interface, etc.

A monitor 544 or other type of display device can be also connected to the system bus 508 via an interface, such as a video adapter 546. It will also be appreciated that in alternative embodiments, a monitor 544 can also be any display device (e.g., another computer having a display, a smart phone, a tablet computer, etc.) for receiving display information associated with computer 502 via any communication means, including via the Internet and cloud-based networks. In addition to the monitor 544, a computer typically comprises other peripheral output devices (not shown), such as speakers, printers, etc.

The computer 502 can operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically comprises many or all of the elements described relative to the computer 502, although, for purposes of brevity, only a remote memory/storage device 550 is illustrated. The logical connections depicted comprise wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which can connect to a global communications network, e.g., the Internet.

When used in a LAN networking environment, the computer 502 can be connected to the LAN 552 through a wired and/or wireless communications network interface or adapter 556. The adapter 556 can facilitate wired or wireless communication to the LAN 552, which can also comprise a wireless AP disposed thereon for communicating with the adapter 556.

When used in a WAN networking environment, the computer 502 can comprise a modem 558 or can be connected to a communications server on the WAN 554 or has other means for establishing communications over the WAN 554, such as by way of the Internet. The modem 558, which can be internal or external and a wired or wireless device, can be connected to the system bus 508 via the input device interface 542. In a networked environment, program modules depicted relative to the computer 502 or portions thereof, can be stored in the remote memory/storage device 550. It will be appreciated that the network connections shown are example and other means of establishing a communications link between the computers can be used.

The computer 502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

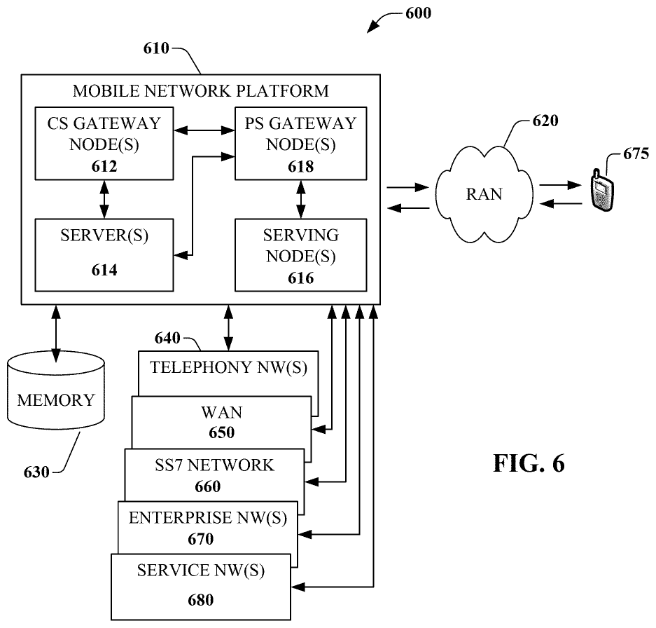

Turning now to FIG. 6, an embodiment 600 of a mobile network platform 610 is shown that is an example of network elements 150, 152, 154, 156, and/or VNEs 430, 432, 434, etc. For example, platform 610 can facilitate, in whole or in part, interactive visualization and exploration of multi-layer alerts for effective anomaly management. In one or more embodiments, the mobile network platform 610 can generate and receive signals transmitted and received by base stations or access points such as base station or access point 122. Generally, mobile network platform 610 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 610 can be included in telecommunications carrier networks, and can be considered carrier-side components as discussed elsewhere herein. Mobile network platform 610 comprises CS gateway node(s) 612 which can interface CS traffic received from legacy networks like telephony network(s) 640 (e.g., public switched telephone network (PSTN), or public land mobile network (PLMN)) or a signaling system #7 (SS7) network 660. CS gateway node(s) 612 can authorize and authenticate traffic (e.g., voice) arising from such networks. Additionally, CS gateway node(s) 612 can access mobility, or roaming, data generated through SS7 network 660; for instance, mobility data stored in a visited location register (VLR), which can reside in memory 630. Moreover, CS gateway node(s) 612 interfaces CS-based traffic and signaling and PS gateway node(s) 618. As an example, in a 3GPP UMTS network, CS gateway node(s) 612 can be realized at least in part in gateway GPRS support node(s) (GGSN). It should be appreciated that functionality and specific operation of CS gateway node(s) 612, PS gateway node(s) 618, and serving node(s) 616, is provided and dictated by radio technology(ies) utilized by mobile network platform 610 for telecommunication over a radio access network 620 with other devices, such as a radiotelephone 675.

In addition to receiving and processing CS-switched traffic and signaling, PS gateway node(s) 618 can authorize and authenticate PS-based data sessions with served mobile devices. Data sessions can comprise traffic, or content(s), exchanged with networks external to the mobile network platform 610, like wide area network(s) (WANs) 650, enterprise network(s) 670, and service network(s) 680, which can be embodied in local area network(s) (LANs), can also be interfaced with mobile network platform 610 through PS gateway node(s) 618. It is to be noted that WANs 650 and enterprise network(s) 670 can embody, at least in part, a service network(s) like IP multimedia subsystem (IMS). Based on radio technology layer(s) available in technology resource(s) or radio access network 620, PS gateway node(s) 618 can generate packet data protocol contexts when a data session is established; other data structures that facilitate routing of packetized data also can be generated. To that end, in an aspect, PS gateway node(s) 618 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 600, mobile network platform 610 also comprises serving node(s) 616 that, based upon available radio technology layer(s) within technology resource(s) in the radio access network 620, convey the various packetized flows of data streams received through PS gateway node(s) 618. It is to be noted that for technology resource(s) that rely primarily on CS communication, server node(s) can deliver traffic without reliance on PS gateway node(s) 618; for example, server node(s) can embody at least in part a mobile switching center. As an example, in a 3GPP UMTS network, serving node(s) 616 can be embodied in serving GPRS support node(s) (SGSN).

For radio technologies that exploit packetized communication, server(s) 614 in mobile network platform 610 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 610. Data streams (e.g., content(s) that are part of a voice call or data session) can be conveyed to PS gateway node(s) 618 for authorization/authentication and initiation of a data session, and to serving node(s) 616 for communication thereafter. In addition to application server, server(s) 614 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 610 to ensure network's operation and data integrity in addition to authorization and authentication procedures that CS gateway node(s) 612 and PS gateway node(s) 618 can enact. Moreover, provisioning server(s) can provision services from external network(s) like networks operated by a disparate service provider; for instance, WAN 650 or Global Positioning System (GPS) network(s) (not shown). Provisioning server(s) can also provision coverage through networks associated to mobile network platform 610 (e.g., deployed and operated by the same service provider), such as distributed antenna networks that enhance wireless service coverage by providing more network coverage.

It is to be noted that server(s) 614 can comprise one or more processors configured to confer at least in part the functionality of mobile network platform 610. To that end, the one or more processors can execute code instructions stored in memory 630, for example. It should be appreciated that server(s) 614 can comprise a content manager, which operates in substantially the same manner as described hereinbefore.

In example embodiment 600, memory 630 can store information related to operation of mobile network platform 610. Other operational information can comprise provisioning information of mobile devices served through mobile network platform 610, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 630 can also store information from at least one of telephony network(s) 640, WAN 650, SS7 network 660, or enterprise network(s) 670. In an aspect, memory 630 can be, for example, accessed as part of a data store component or as a remotely connected memory store.

In order to provide a context for the various aspects of the disclosed subject matter, FIG. 6, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

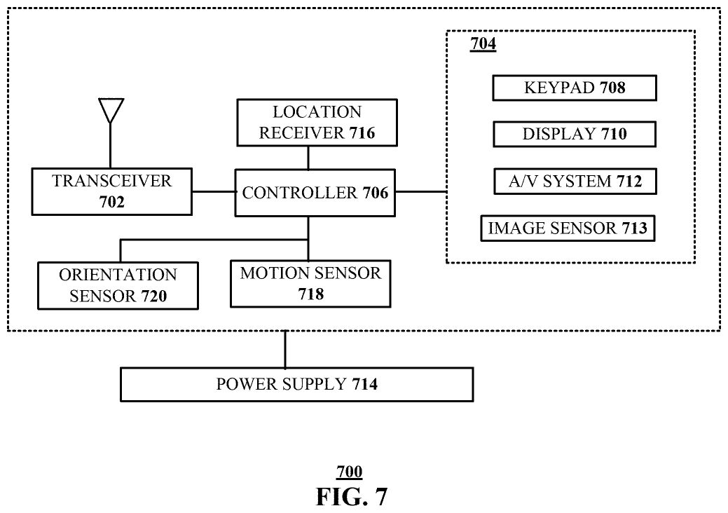

Turning now to FIG. 7, an illustrative embodiment of a communication device 700 is shown. The communication device 700 can serve as an illustrative embodiment of devices such as data terminals 114, mobile devices 124, vehicle 126, display devices 144 or other client devices for communication via communications network 125. For example, computing device 700 can facilitate, in whole or in part, interactive visualization and exploration of multi-layer alerts for effective anomaly management.

The communication device 700 can comprise a wireline and/or wireless transceiver 702 (herein transceiver 702), a user interface (UI) 704, a power supply 714, a location receiver 716, a motion sensor 718, an orientation sensor 720, and a controller 706 for managing operations thereof. The transceiver 702 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 702 can also be adapted to support circuit-switched wireline access technologies (such as PSTN), packet-switched wireline access technologies (such as TCP/IP, VoIP, etc.), and combinations thereof.

The UI 704 can include a depressible or touch-sensitive keypad 708 with a navigation mechanism such as a roller ball, a joystick, a mouse, or a navigation disk for manipulating operations of the communication device 700. The keypad 708 can be an integral part of a housing assembly of the communication device 700 or an independent device operably coupled thereto by a tethered wireline interface (such as a USB cable) or a wireless interface supporting for example Bluetooth®. The keypad 708 can represent a numeric keypad commonly used by phones, and/or a QWERTY keypad with alphanumeric keys. The UI 704 can further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 708 can be presented by way of the display 710 with navigation features.

The display 710 can use touch screen technology to also serve as a user interface for detecting user input. As a touch screen display, the communication device 700 can be adapted to present a user interface having graphical user interface (GUI) elements that can be selected by a user with a touch of a finger. The display 710 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 710 can be an integral part of the housing assembly of the communication device 700 or an independent device communicatively coupled thereto by a tethered wireline interface (such as a cable) or a wireless interface.

The UI 704 can also include an audio system 712 that utilizes audio technology for conveying low volume audio (such as audio heard in proximity of a human ear) and high volume audio (such as speakerphone for hands free operation). The audio system 712 can further include a microphone for receiving audible signals of an end user. The audio system 712 can also be used for voice recognition applications. The UI 704 can further include an image sensor 713 such as a charged coupled device (CCD) camera for capturing still or moving images.

The power supply 714 can utilize common power management technologies such as replaceable and rechargeable batteries, supply regulation technologies, and/or charging system technologies for supplying energy to the components of the communication device 700 to facilitate long-range or short-range portable communications. Alternatively, or in combination, the charging system can utilize external power sources such as DC power supplied over a physical interface such as a USB port or other suitable tethering technologies.

The location receiver 716 can utilize location technology such as a global positioning system (GPS) receiver capable of assisted GPS for identifying a location of the communication device 700 based on signals generated by a constellation of GPS satellites, which can be used for facilitating location services such as navigation. The motion sensor 718 can utilize motion sensing technology such as an accelerometer, a gyroscope, or other suitable motion sensing technology to detect motion of the communication device 700 in three-dimensional space. The orientation sensor 720 can utilize orientation sensing technology such as a magnetometer to detect the orientation of the communication device 700 (north, south, west, and east, as well as combined orientations in degrees, minutes, or other suitable orientation metrics).

The communication device 700 can use the transceiver 702 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 706 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 700.

Other components not shown in FIG. 7 can be used in one or more embodiments of the subject disclosure. For instance, the communication device 700 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving, via an interactive user interface, user selections of a dataset and a first dimension of a plurality of dimensions in a hierarchical structure associated with the dataset, wherein the dataset corresponds to a specific domain and comprises anomalies or alerts that are aggregated in certain dimensions of the plurality of dimensions, and wherein a lattice of aggregations of the anomalies or alerts is defined for the specific domain; and
responsive to the receiving the user selections, causing the interactive user interface to present a time series chart and a heatmap, wherein the time series chart portrays alert density across dimensions of the plurality of dimensions that are below the first dimension, wherein the heatmap displays, according to a visual scheme, concentrations of the anomalies or alerts across at least a portion of the dimensions that are below the first dimension, and wherein user interaction with either or both of the time series chart and the heatmap facilitates navigation of subspaces of the lattice and exploration of the concentrations of the anomalies or alerts.

2. The device of claim 1, wherein the heatmap displays the concentrations of the anomalies or alerts across a remaining two dimensions of the plurality of dimensions.

3. The device of claim 2, wherein the heatmap comprises a plurality of cells that each corresponds to the remaining two dimensions of the plurality of dimensions, and wherein the operations further comprise receiving, via the interactive user interface, a user selection of a given cell of the plurality of cells, and causing, based on the receiving the user selection, the interactive user interface to present a second time series chart that portrays an individual metric without aggregation.

4. The device of claim 2, wherein the remaining two dimensions correspond to pods and gauges.

5. The device of claim 1, wherein the lattice of aggregations comprises nodes and edges, wherein each of the nodes corresponds to a level of the aggregations, and wherein each of the edges corresponds to a particular dimension that needs to be specified to arrive at a particular aggregation.

6. The device of claim 1, wherein the visual scheme comprises a color-based scheme in which different colors correspond to different concentrations of anomalies or alerts.

7. The device of claim 1, wherein the operations further comprise receiving a user selection of a time window, and wherein the causing the interactive user interface to present the time series chart and the heatmap is in accordance with the time window.

8. The device of claim 1, wherein the user interaction includes selections of one or more alerts portrayed in the time series chart, selections of one or more portions of the heatmap, or a combination thereof to zoom in to or zoom out to various subspaces of the lattice.

9. The device of claim 1, wherein the user interaction includes adjustments to ranges of dimensions to modify dimensions of an explored subspace of the lattice.

10. The device of claim 1, wherein the alerts are generated from monitored data streams provided by an anomaly detection and alerting system.

11. The device of claim 10, wherein the anomaly detection and alerting system is configured to monitor applications or systems on a cloud environment, one or more data lakes, one or more data centers, one or more distributed content delivery networks, one or more machine learning (ML) applications associated with one or more data sources, or a combination thereof.

12. The device of claim 1, wherein the dataset is partitioned based on the hierarchical structure.

13. A non-transitory machine-readable medium, comprising executable instructions that, when executed by a processing system including a processor, facilitate performance of operations, the operations comprising:
obtaining a dataset from an anomaly detection and alerting system, wherein the dataset is associated with a plurality of dimensions in a hierarchical structure, wherein the dataset corresponds to a specific domain and comprises anomalies or alerts that are aggregated in certain dimensions of the plurality of dimensions, and wherein a lattice of aggregations of the anomalies or alerts is defined for the specific domain; and
presenting an interactive user interface that includes a time series chart and a heatmap, wherein the time series chart portrays alert density across various dimensions of the plurality of dimensions, wherein the heatmap displays concentrations of the anomalies or alerts across particular dimensions of the plurality of dimensions, and wherein user interaction with the time series chart or the heatmap facilitates navigation of subspaces of the lattice.

14. The non-transitory machine-readable medium of claim 13, wherein facilitating the navigation of subspaces of the lattice enables identification of one or more causal events for the concentrations of the anomalies or alerts.

15. The non-transitory machine-readable medium of claim 13, wherein the alerts comprise super alerts generated based on at least one of persistence and pervasiveness of baseline alerts.

16. The non-transitory machine-readable medium of claim 15, wherein the alerts further comprise smart alerts generated based on at least one of priority, anomaly persistence, and pervasiveness of the super alerts over multiple data streams or multiple dimensions of the plurality of dimensions.

17. A method, comprising:
receiving, by a processing system including a processor, and from an interactive dashboard, a first user selection of a dataset and a second user selection of a first dimension of a plurality of dimensions in a hierarchical structure associated with the dataset, wherein the dataset corresponds to a specific domain and comprises anomalies or alerts that are aggregated in certain dimensions of the plurality of dimensions, and wherein a lattice of aggregations of the anomalies or alerts is defined for the specific domain;
based on the receiving the first user selection and the second user selection, causing, by the processing system, the interactive dashboard to display a first time series chart and a heatmap, wherein the first time series chart portrays alert density across various dimensions of the plurality of dimensions, and wherein the heatmap presents, according to a visual scheme, concentrations of the anomalies or alerts across particular dimensions of the plurality of dimensions;
receiving, by the processing system, and from the interactive dashboard, a third user selection of a portion of the heatmap; and
based on the receiving the third user selection, causing, by the processing system, the interactive dashboard to display a second time series chart that portrays an individual metric without aggregation.

18. The method of claim 17, wherein each of the first time series chart and the second time series chart is represented according to a standardized residual.

19. The method of claim 17, wherein the anomalies or alerts relate to measurements for memory usage, central processing unit (CPU) utilization, graphics processing unit (GPU) utilization, disk utilization, network load, CPU heat level, GPU heat level, number of concurrent users, or a combination thereof.

20. The method of claim 17, wherein the heatmap is displayed along with a density indicator that provides information regarding the visual scheme.
